(19) United States
(12) Patent Application Publication
(10) Pub. No.: US 2003/0033260 A1
(43) Pub. Date: Feb. 13, 2003

(54) Method and apparatus for facilitating the repair of malfunctioning or inoperable products

(76) Inventors: Tatsuo Yashiro, Williston Park, NY (US); Walter T. Inglesby, Farmingdale, NY (US); Shin Kiuchi, Princeton Junction, NJ (US)

Correspondence Address: FITZPATRICK CELLA HARPER & SCINTO, 30 ROCKEFELLER PLAZA, NEW YORK, NY, 10112, US

(21) Appl. No.: 09/948,561

(22) Filed: Sep. 10, 2001

Related U.S. Application Data
(60) Provisional application No. 60/285,398, filed on Apr. 20, 2001.

(51) Int. Cl. G06F 17/00

(52) U.S. Cl. 705/400

(57) ABSTRACT

A network sever for facilitates the repair of a product. The server receives information from the network identifying the product to be repaired and receives information from the network identifying a repair class for the product, the repair class having been selected from among a predetermined set of repair classes and characterizing a level difficulty of repair for the product. The server determines an estimated cost of repair for the product, based upon a metric that considers the repair class for the product, tracks the actual amount of time required to repair the product and selectively modifies the metric based upon the actual amount of time tracked.

### CROSS-REFERENCE TO RELATED APPLICATION

This application claims the benefit of U.S. Provisional Patent Application No. 60/285,398, filed Apr. 20, 2001.

### BACKGROUND OF THE INVENTION

1. Field of the Invention

The present invention is directed to a computer-based system for facilitating a program for repairing malfunctioning or inoperable products that have been brought to a service center for servicing. In a preferred embodiment of the present invention, a central computer maintains a database of all products which are supported by the system, including technical information and parts information relating to such products; and automatically generates the appropriate amount, if any, to be charged to the consumer for such servicing.

2. Related Art

A manufacturer's ability to support its products is often a key factor that a consumer considers in determining whether to make a contemplated purchase. One key form of support with which a consumer is concerned is the repair of purchased products that malfunction or become inoperable, either due to a design or manufacturing defect, the consumer's own negligence, ordinary wear and tear, or some other cause. If a consumer is not confident that a product can be repaired expeditiously in the event that it breaks down or is damaged, he or she may never purchase the product in the first place. Thus, a manufacturer's offering of an efficient and reliable support and service program for its products can often contribute as much to sales as the quality and features of the products themselves.

It is commonplace for manufacturer's of technically complex products—such as for example cameras, video recorders, computers and the like—to support its products through a variety of service providers. These include “in-house” factory service repair centers (which may be at the same physical location as a manufacturing facility or at an off-site location, but which are in any case part of the manufacturing company); sub-contractors which are provided by the manufacturing company with products that have been returned to the manufacturing company for repair, and which then effect the actual repairs for a fee; independent authorized service facilities, which are sanctioned by the manufacturing company as being qualified to repair certain or all of its products (such facilities may or may not also function as dealers of the products they are authorized to repair); or some combination of the three.

Irrespective of which party is making the actual repairs, the process begins with a product being either shipped or brought by a consumer to a service provider, followed by the service provider's receipt and in-take of the product. The service provider will then typically inspect the product, ascertain the extensiveness of the repairs that need to be made and estimate what the costs of those repairs (generally in terms of parts, shipping and labor) will be. In some cases, the service provider will determine that the consumer should not be charged for the repairs, such as for example in a case where the product and the damages thereto are covered by a warranty. In any case, the service provider will communicate the costs to the consumer, obtain approval from the consumer to perform the work at that price and, if approval is obtained, effect the actual repairs.

Despite being generally effective at providing a support network for the repair of products, existing systems have drawbacks. One such drawback stems from the fact that the cost estimation process is performed manually and on an ad hoc basis, and is thus cumbersome, slow and often inadequate at providing a realistic estimate of what the actual repairs will be. Such inaccurate estimates may result in the service provider charging a consumer too much or too little for repairs, or in a consumer being changed more for repairs than the amount he was originally quoted. None of these results, of course, is satisfactory.

Also, the processes of cost estimation and repair often require the technician consult certain technical references, such as service manuals, service manual bulletins, assembly drawings, parts lists, parts data sheets and the like. These materials are available to many service providers, including in both hard-copy and electronic form, but are often poorly organized, such that accessing them for their intended purposes is time-consuming.

Another problem with existing systems is in communicating the estimate to the consumer to obtain approval to perform the repairs. In conventional systems, such communication is accomplished by having the estimator manually draft a letter (which may be sent via facsimile, mail, electronic mail, etc), setting forth the details of what servicing is required and what it will cost. Having an estimator prepare such a letter for each product that comes in, however, is burdensome, and further increases the overall turn-around time required to move a repaired product back to the consumer.

Canadian Patent Documents 2,006,686 is directed to an order entry system in which a host computer stores text data relating to parts information, and a local computer stores graphic data corresponding to the text data, that includes displayable parts diagrams. The parts information may include a parts number, a part description, an assembly number, the number of parts in an assembly, units of measurements, lot size, lead time and price. In U.S. Pat. No. 5,283,865, a computerized system is described, which provides a salesperson with assistance related to the training and sales of parts corresponding to particular products. A data storage device stores graphic and textual parts-related information, including specifications, features and customer benefits. A display apparatus electronically displays portions of the information, in order to provide training and sales assistance. A parts selection device electronically selects a particular part by navigating through parts choice menus based upon stored parts specifications, and a user interface controls the operation of the display apparatus and the part selection device, so that each of the parts are operatively coupled and related to one another.

Both Canadian 2,006,686 and U.S. Pat. No. 5,283,865, however, are merely directed to parts order entry systems, and do not provide a system for facilitating a product repair program.

U.S. Pat. No. 5,596,712 is directed to a method a system for diagnosing and analyzing product troubles. In this system, a fault tree representing relations between faults and causes is generated, based upon information of past faults, and information concerning the structure and characteristics of the product. The fault tree has branches allocated with weighting coefficients, and is searched in accordance with the weighting coefficients to determine the cause of a fault. Information concerning adjustment or repairs of the product suffering from the fault are generated and output, and information concerning the timing of the occurrence of the fault, symptoms appearing in the fault and adjustment and repair are supplied, to construct a database for the fault information. U.S. Pat. No. 5,596,712, however, is strictly limited to diagnosis and analysis of product troubles, and does not describe an overall system for facilitating the administration of a product repair program.

There is a need, therefore, for a system and method for facilitating a program for repairing products that takes an entirely fresh approach, departs from the old, out-dated approaches of the prior art and overcomes the drawbacks that have plagued them.

### SUMMARY OF THE INVENTION

The present invention addresses the above concerns and presents new and novel apparatuses and processes for facilitating the repair of malfunctioning or inoperable products.

In accordance with one embodiment of the present invention, a network sever facilitates the repair of a product. The server is adapted to receive information from the network identifying the product to be repaired; receive information from the network identifying a repair class for the product, the repair class having been selected from among a predetermined set of repair classes and characterizing a level difficulty of repair for the product; determine an estimated cost of repair for the product, based upon a metric that considers the repair class for the product; track an actual amount of time required to repair the product; and selectively modify the metric based upon the actual amount of time tracked.

In accordance with another embodiment of the present invention, a system is provided for facilitating the repair of a product. The system comprises means for receiving information identifying the product to be repaired; means for receiving information identifying a repair class for the product, the repair class having been selected from among a predetermined set of repair classes and characterizing a level difficulty of repair for the product; means for determining an estimated cost of repair for the product, based upon a metric that considers the repair class for the product; means for tracking an actual amount of time required to repair the product; and means for selectively modifying the metric based upon the actual amount of time tracked.

In yet another embodiment of the present invention, computer code facilitates the repair of a product. The code includes code for receiving information identifying the product to be repaired; code for receiving information identifying a repair class for the product, the repair class having been selected from among a predetermined set of repair classes and characterizing a level difficulty of repair for the product; code for determining an estimated cost of repair for the product, based upon a metric that considers the repair class for the product; code for tracking an actual amount of time required to repair the product; and code for selectively modifying the metric based upon the actual amount of time tracked.

In still another embodiment of the present invention, there is provided a method for facilitating the repair of a product that is received from a consumer, the product having been assigned a price class from among a predetermined set of price classes. Included in the method are the steps of inputting product information and consumer information to a client computer; transmitting the product information and consumer information to a network server; inspecting the product to determine a difficulty of repairs; characterizing the difficulty of repairs in terms of a repair class; transmitting the repair class to the network server; computing an estimated cost of repair for the product based upon the repair class for the product and the price class for the product; and communicating the estimated cost of repair to the consumer.

In yet another embodiment of the present invention, a system facilitates the repair of a product that is received from a consumer, the product having been assigned a price class from among a predetermined set of price classes. The system includes a client computer that receives product information, consumer information and a repair class for the product, the repair class having been determined following a inspection of the product and characterizing the difficulties of repairs; and a network server that receives the product information and the consumer information from the client computer, computes an estimated cost of repair for the product based upon the repair class for the product and the price class for the product and communicates the estimated cost of repair to the consumer.

### BRIEF DESCRIPTION OF THE DRAWINGS

FIG. 1 is high-level block diagram for implementing the methods and systems of the present invention.

FIG. 1A is a high-level flowchart depicting implementation of the present invention.

FIG. 2 is a Home page for a manufacturer of consumer products.

FIG. 3 is a Web page for accessing a repair system.

FIG. 4 is a top level Web page of the repair system providing hyperlinks to receiving, estimation, service, and shipping Web pages.

FIG. 4A is a flowchart depicting implementation of the receiving phase.

FIG. 5 is a receiving Web page of the repair system, which allows entry of product and consumer information.

FIG. 6 is a Web page showing the reference number assigned to the product and providing a hyperlink to print out a bar code label.

FIG. 7 is a bar code label for a product being serviced.

FIG. 8 is a Web page for entering a repair reference number of a product to retrieve product information and initiate the estimation process.

FIG. 8A is a flowchart depicting implementation of the estimating phase.

FIG. 9 is a Web page providing product and consumer information and providing access to an estimation Web page.

FIG. 10 is an estimation Web page for entering repair information for calculation of the repair estimate.

FIG. 10A is a Web page providing an assembly drawing of a product.

FIG. 11 is an example of the estimation Web page with entered repair information.

FIG. 12 is an example of the estimation Web page with computed repair costs.

FIG. 13 is an example of a table providing estimated labor costs for products assigned to particular price classes.

FIG. 13A is another example of a table, providing estimated labor hours and labor cost.

FIG. 13B is a flowchart depicting implementation of the servicing phase.

FIG. 14 is a Web page for entering a repair reference number of a product to retrieve product information and initiate the service process.

FIG. 15 is a service Web page for providing product information and actual repair time tracking.

FIG. 15A is Web page for entering repair details during the servicing phase.

FIG. 15B is a flowchart depicting implementation of the shipping phase.

FIG. 16 is a Web page for entering a repair reference number of a product to retrieve product and consumer information and initiate the shipping process.

FIG. 17 is a shipping Web page for entering shipping information and printing a shipping label.

### DETAILED DESCRIPTION OF THE PREFERRED EMBODIMENTS

“Consumer” means generally any person or entity who desires to or has purchased a consumer product, and who in the context of the present invention wishes to have that product serviced or repaired. In preferred embodiments, the consumer is the individual or entity actually buying and using the consumer product.

“Manufacturer” means the person or entity organizing and authorizing the repair program. In preferred embodiments, the entity organizing and authorizing the repair program is, in fact, the entity which actually manufactured the product. Nevertheless, this is not required of the system and method as broadly disclosed herein.

“Consumer product” or sometimes simply “product” means any product under the sun. In one preferred embodiment, the consumer product a camera. However, the system and methods according to the invention can be adapted to any consumer product, including without limitation, camcorders, copying machines, computers, home appliances such as coffee makers or washing machines, boats, automobiles, motorcycles, sporting equipment such as skis or golf clubs, and furniture, just to name a few.

“Computer” may refer to a single computer or to a system of interacting computers. Generally speaking, a computer is a combination of a hardware system, a software operating system and perhaps one or more software application programs. Examples of computers include, without limitation, IBM-type personal computers (PCs) having an operating system such as DOS, Windows, OX/2 or Linux; Macintosh computers; hardware having a JAVA-OS operating system; graphical work stations, such as Sun Microsystems and Silicon Graphics Workstations having a UNIX operating system; PalmPilots; and PilotPCs.

“Network” means a connection between any two or more computers, which permits the transmission of data. An example of a network is the Internet.

“Client/server” architecture is a network architecture in which each computer or process on the network is either a “client” or a “server”. A “server” is a computer or device on a network that manages network resources and is operable to receive requests from third parties on the network and respond to those requests. Requests are sent to a server by a “client”, typically an application that runs on a personal computer or workstation and relies on the server to perform some operations. A client preferably has a Web browser.

“User identification information” is consumer information that uniquely describes a consumer and includes, without limitation, user ID and password information.

“Web page” means any documents written in mark-up language including, but not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific site on the World Wide Web (“Web”), or any document obtainable through a particular URL (Uniform Resource Locator).

“Web site” means at least one Web page, and preferably a plurality of Web pages, virtually connected to form a coherent group.

“Web browser” means any client software program running on a computer which can display text, graphics, or both, from Web pages on Web sites. Examples of Web browsers include, without limitation, Netscape Navigator and Microsoft Internet Explorer.

“Web server” is a server which is capable of serving at least one Web page to a Web browser.

The phrase “display a Web page” includes all actions necessary to render at least a portion of the information on the Web page available to the computer user. As such, the phrase includes, but is not limited to, the static visual display of static graphical information, the audible production of audio information, the animated visual display of animation and the visual display of video stream data.

For the present invention, a software application could be written in substantially any suitable programming language, which could easily be selected by one of ordinary skill in the art. The programming language chosen should be compatible with the computer by which the software application is executed, and in particular with the operating system of that computer. Examples of suitable programming languages include, but are not limited to, C, C++, CGI, Java and Java Scripts. Furthermore, the functions of the present invention, when described as a series of steps for a method, could be implemented as a series of software instructions for being operated by a data processor, such that the present invention could be implemented as software, firmware or hardware, or a combination thereof.

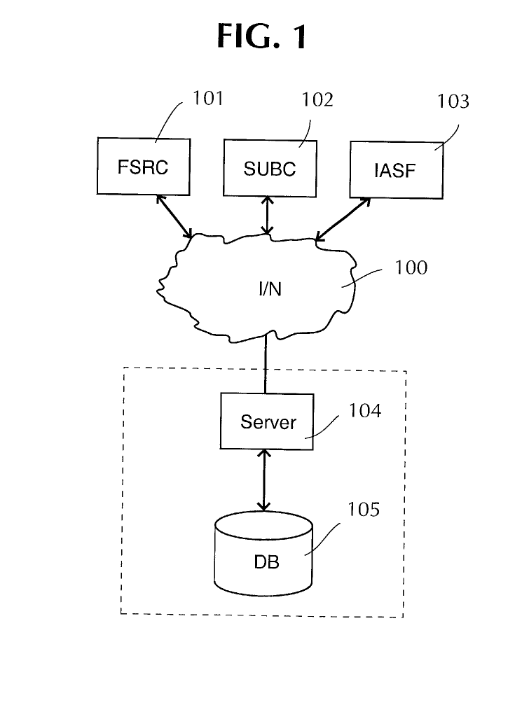

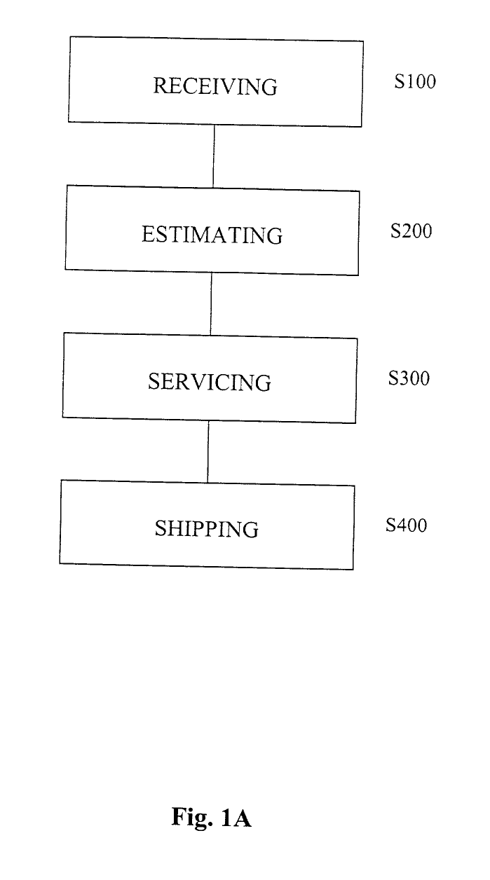

One basic system configuration for implementing the present invention is depicted in FIG. 1. In that configuration, client computer 101 at a factory service repair center (FSRC), client computer 102 at a subcontractor (SUBC) facility and client computer 103 at an independent authorized service facility (IASF) all communicate with a server 104, maintained by or on behalf of a manufacturer. The communication is preferably via a wide area network (WAN), such as for example the Internet 100. The connections to the Internet may be direct or via an Internet Service Provider (ISP) (not shown).

The server 104 also communicates with a database (DB) 105, which stores such information as the products that the repair program supports, technical and parts information regarding those products, information concerning registered users and other kinds of data that will be discussed in greater detail below. Preferably, the database 105 is maintained on a database server, and comprises a relational database management system (RDBMS), in which stored information is arranged in tables of rows and columns, related to one another by predetermined functions, and can be accessed by database query protocols, such as for example the Structured Query Language (SQL). Also, the database 105 may in actuality be several databases, such as for example a parts database, a customer database, a billing database, etc., each of which is maintained on a separate database server.

The server 104 is preferably an Internet (TCP/IP compliant) server that interacts with client computers 101-103, and other client computers, using the client computers, graphical user interfaces (GUI), which allow users of those client computers to interact with the server to participate in the product repair program that the server administrates. Functionality is preferably achieved using a combination of server side applications, such as common gateway interface programs (CGI), for allowing the server to accept requests and interface with databases, and client side applets, such as Java applets, or the like, which execute in client browser software.

The client computers each preferably include communications hardware and an operating system with graphical user interface (GUI) functionality to allow for interface with the Internet. Each client computer preferably has graphical Web browser software, such as Netscape Navigator or Microsoft Internet Explorer, loaded thereon operable to read and send Hypertext Markup Language (HTML) forms from and to a Hypertext Transfer Protocol (HTTP) server on the Web. The client computer 1 preferably is operable to act as a virtual machine to run Java applets, or the like, downloaded by the browser from the server. The server 104 receives information from the client computers over the Internet. The server preferably includes hardware, HTTP compliant software, an operating system and common gateway interface (CGI) software for interfacing with input queries and sources of data.

It should of understood, of course, that configurations other than that illustrated in FIG. 1 are also possible. For example, the FSRC computer 101 may be housed in the same facility as the server 104, and may communicate with the server 104 through a local area network (LAN), rather than through the Internet. Or all communications may be through a LAN, or a WAN other than the Internet, or through dedicated connections. Also, it is possible for the same independent facility (i.e., independent from the manufacturer) to function as both a SUBC, repairing products that have been brought to the manufacturer by the consumer and then brought to it by the manufacturer; and an IASF, repairing products that have been brought directly to it by the consumer. Other configurations are possible as well.

In a preferred embodiment of the present invention, a product submitted for repair may go through several phases, including, as shown in the flowchart of FIG. 1A, a receiving phase (S100), an estimation phase (S200), a servicing phase (S300), and a shipping phase (S400). Each of these phases will be described in greater detail below. A particularly advantageous aspect of the systems and methods of the present invention is that upon receiving a product to be repaired, an operator inputs certain core information concerning that product, which is then used by the server 104 to create a unique record for the product that is stored in the database 105. This allows needed information concerning the product to be retrieved readily in later phases of the process.

When a product is brought or shipped by a consumer for servicing or repair, it initially enters the receiving phase (S100) of the program. In the embodiment depicted in FIG. 1, products may be brought or shipped by consumers to FSRCs or IASFs, but not to SUBC's, which are typically provided the products that they will be servicing or repairing by an FSRC (unless the SUBC is also an IASF, as described above). An operator at the FSRC or IASF is charged with receiving the products that have been brought in. In a preferred embodiment of the present invention, the operator may access the system via the Web, from a client computer 101 or 103, by initially connecting to the home page of the manufacturer of the product.

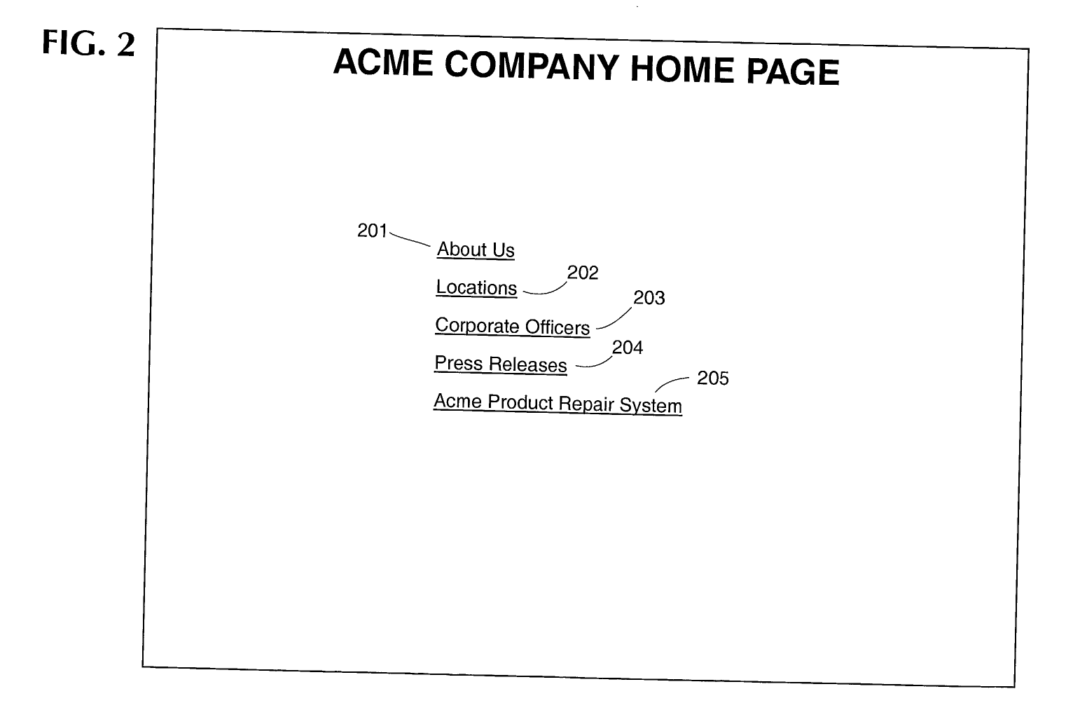

An exemplary manufacturer home page is illustrated in FIG. 2, and includes a hyperlink to various Web site pages, including, a hyperlink 201 to a page that provides general information about the company; a hyperlink 202 that provides information concerning company locations; a hyperlink 203 that provides information concerning the company's corporate officers; and a hyperlink 204 to a page that provides company press releases. Such hyperlinks are commonplace. In addition, and in accordance with the present invention, the home page of FIG. 2 also provides a hyperlink 205 which the operator may click to access the product repair system.

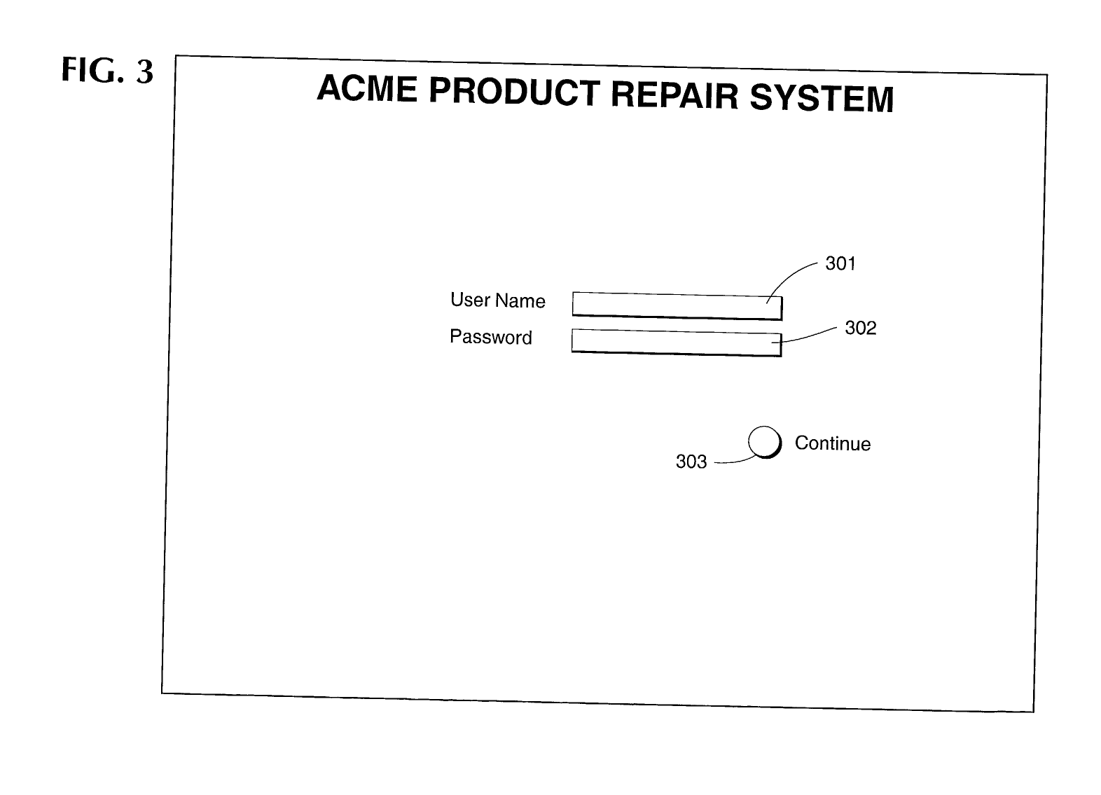

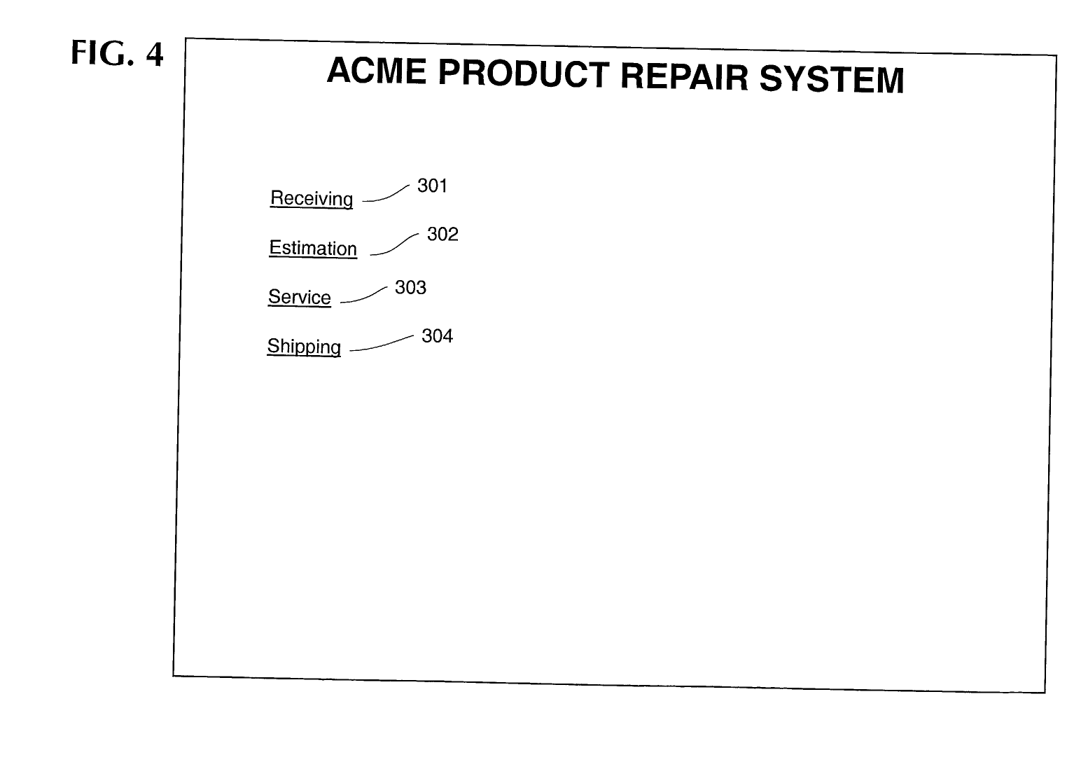

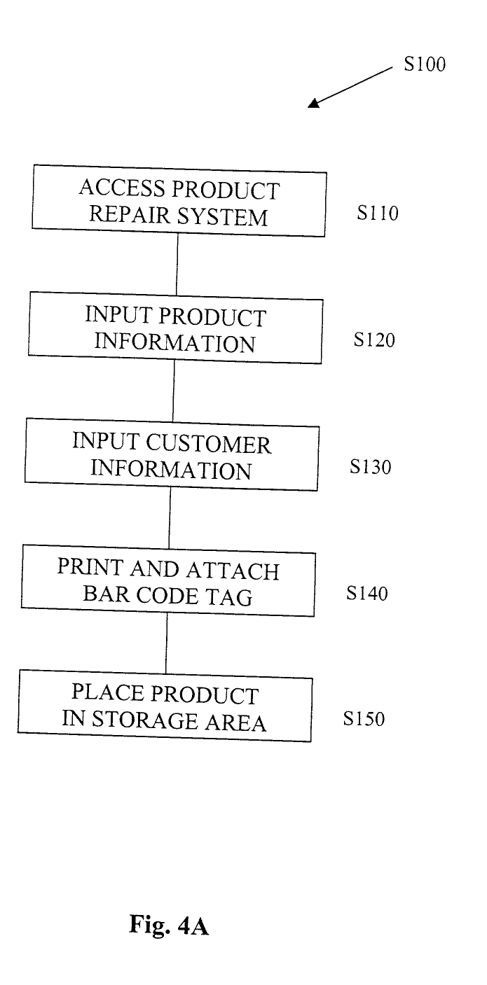

In a preferred embodiment, the product repair system is only accessible to registered users. Accordingly, the clicking of hyperlink 205 preferably causes the client computer to be served with a Web page along the lines of FIG. 3, prompting the operator to enter a previously assigned user name (in field 301) and password (in field 302) to gain access to the system. Upon the operator's clicking of the continue button 303, the input information is provided to the server 104, which correlates the user name and password with information stored in database 105, to determine its validity. If valid, the server 104 serves the client with the Web page at FIG. 4, which is the initial screen of the product repair system. This page provides a hyperlink for each phase of the system, including a hyperlink 301 for the receiving phase (S100); a hyperlink 302 for the estimation phase (S200); a hyperlink 303 for the service phase (S300); and a hyperlink 304 for the shipping phase (S400). If the system incorporates additional phases—such as for example an inspection phase—then hyperlinks for those additional phases might be provided on this page as well.

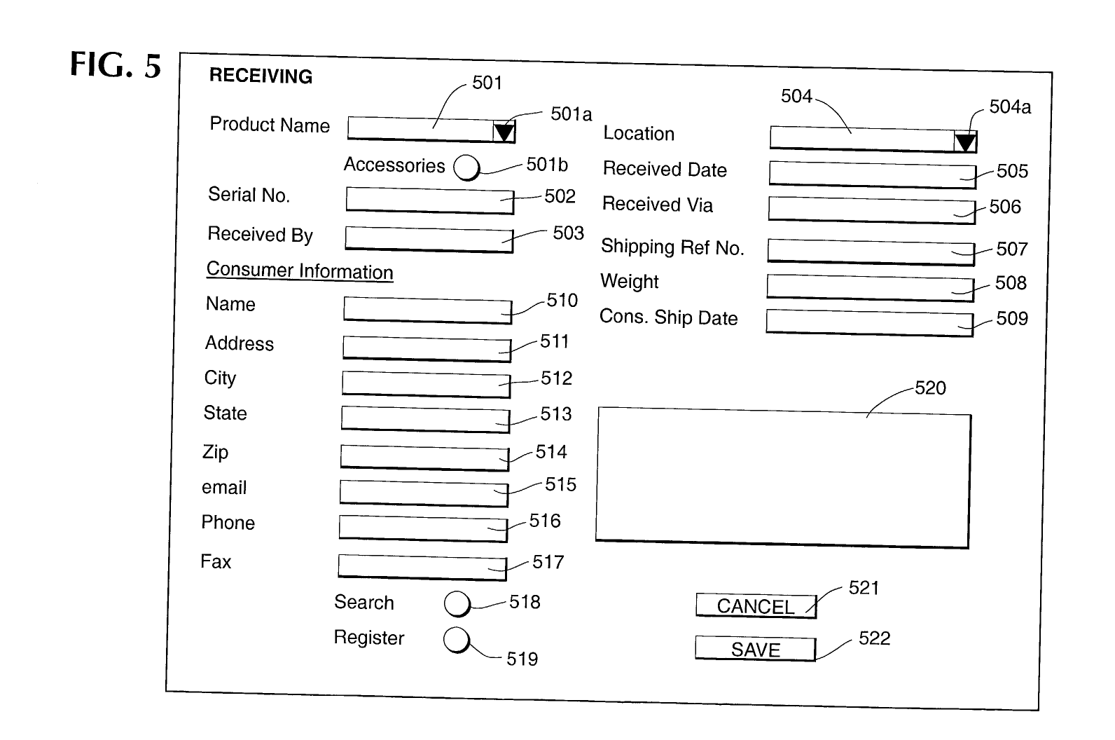

The steps of the receiving phase are shown in the flowchart of FIG. 4A, including the step of accessing the repair system (S110), as described above. An operator administering the receiving phase would, of course, click the receiving hyperlink 301, and be served a Web page along the lines of that shown in FIG. 5. Generally speaking, the page comprises multiple fields into which the operator inputs information concerning the product being received, the consumer who sent the product, etc., along with some functional buttons.

Using the Web page shown in FIG. 5, the operator enters information about the product (S120). The “product name” field 501 is for inputting the name (e.g. model name) of the product to be repaired. The “serial number” field 502 is for the serial number of the specific product. The “received by” field 503 is for the name or identification number of the receiving operator. The information in the received by field may be automatically provided by the server, based on the user name provided to the server upon accessing the repair system. The “received via” field 506 is for the manner in which the product was received, e.g. by UPS, via FedEx, a by-hand drop-off, etc. The “shipping reference number” field 507 is for the shipping reference number of the carrier that delivered the product, if applicable. In a most preferred embodiment, the shipping reference number is input by scanning a bar code on the carrier's shipping label. The “weight” field 508 is for the shipping weight of the product. The “consumer ship date” field 509 is for the date on which the product was originally shipped by the consumer.

The consumer information fields 510-517 are for inputting information about the consumer (S130), which, as shown in FIG. 5, is self-explanatory. In a particularly preferred embodiment of the present invention, the database 105 stores profile information on certain consumers who have purchased products, such as, for example, those consumers who have registered their products under a warranty program, those consumers who have in the past brought products in for repair, etc. In such a case, the operator enters the name of the consumer in the “name” field 510 and clicks the search button 518. The server 104 receives the input name, queries the database 105 and, if that consumer is in the database, retrieves the consumer's profile information and uses it to populate fields 511-517.

If the consumer is not in the database 105, the server 104 provides a message to that effect to the client (such as via a pop-open box), and the operator inputs the consumer information into fields 511-517 manually. In such a case, the operator may subsequently click the register button 519 upon completion, causing the server 104 to provide the newly input consumer information to the database 105 to create a profile. Alternatively, the server may automatically create such a profile.

In addition, the Web page of FIG. 5 may be provided with a field 520, into which free-text may be entered by the operator, to provide comments that may be unique to that product. Also, some or all of the fields may be provided with arrow icons (such as down arrows 501a and 504a shown in FIG. 5), which the operator may click to obtain a pull-down menu, obviating the need to manually input text. For example, clicking on arrow 501a displays a pull-down menu of all products supported by the program, among which the operator may select. In a similar fashion, clicking on the arrow 504a displays a pull-down menu of all locations that the program supports. Plainly, the pull-down menu technique may be used in connection with other fields as well. For example, even the so-called free-text field 520 may be provided with a pull-down menu, which comprises several pre-typed comments that a receiving operator is likely to wish to input.

Another mechanism for assisting the operator is inputting data is a filtering technique, which provides the operator with various options as characters are entered into a given field. For example, if the filtering technique is used in connected with the product name field 501, and the operator inputs the letter “E,” a drop-down menu appears below the field 501, containing all products beginning with the letter “E” that the system supports. The operator may then select among those menu options. Alternatively, the operator may type an additional letter, such as “L,” which would have the effect of shortening the menu to those supported products beginning with “EL.” The operator may then select among those options, or type additional letters to shorten the list.

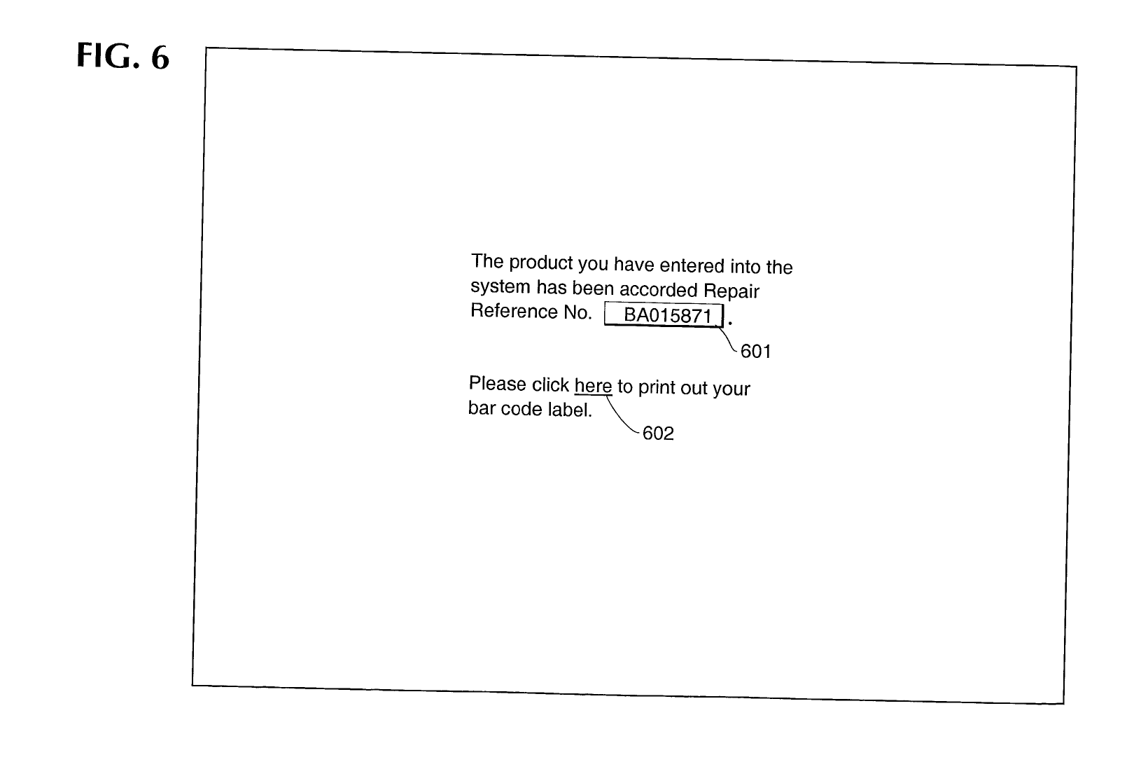

The operator may click on the cancel button 520 at any time, to clear all of the fields of the data that has been input. When the operator has completed the form and is satisfied with the data he has input, he clicks the save button 521. The input data are provided to the server 104, and stored in the database 105. In addition, the server generates a Repair Reference Number and a unique bar code that it associates with the product that has been received. These are provided to the client by serving a Web page along the lines of FIG. 6. This page provides the operator with the assigned Repair Reference Number in field 601 (in this example, BA015871), and also with a hyperlink 602 which may be clicked to print a bar code label (S140).

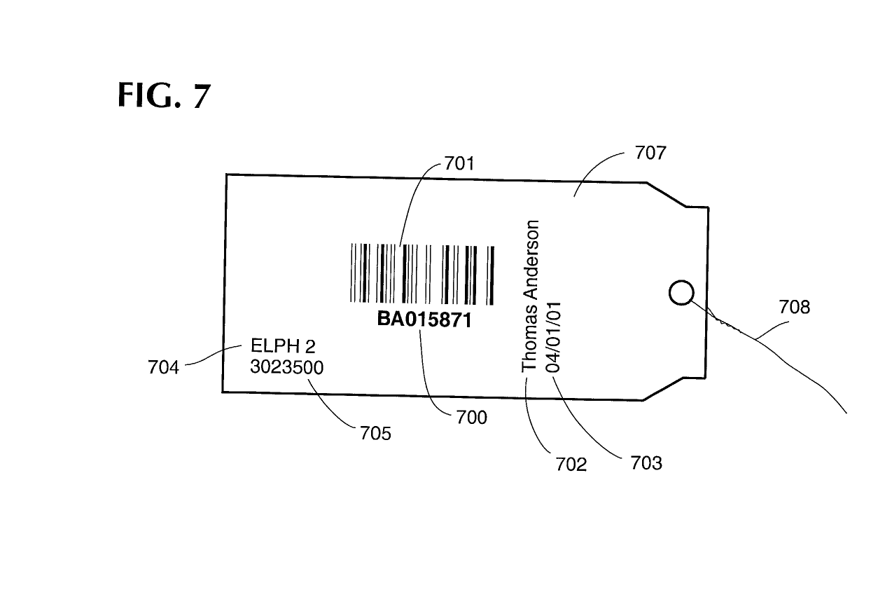

An exemplary bar code label is illustrated in FIG. 7. The label includes the Repair Reference Number 700; the actual bar code 701; the name of the receiving operator 702 (in this case, Thomas Anderson); the date of receiving 703 (in this case, Apr. 1, 2001); and the model name of the product 704 (in this case, ELPH2) and product serial no. 705 (in this case, 3023580). In a most preferred embodiment of the present invention, the label is affixed to a tag 707, which tag 707 is itself tied to the product by a (preferably elastic) string 708, and remains so affixed until the product is shipped back to the consumer. In this manner, any and all operators who conduct the product through subsequent phases (e.g. the estimation phase, the service phase and the shipping phase) can readily retrieve all needed information associated with the product and contained in the database 105, by scanning the bar code on the tag.

Once a product is received into the system in the manner described above, it is placed into a storage area, with its bar code tag, to await the next phase (S150). In due course, the product enters the estimation phase (S200), in which it is removed from the storage area by an estimating operator, and inspected to assess the extent of the repairs that need to be performed.

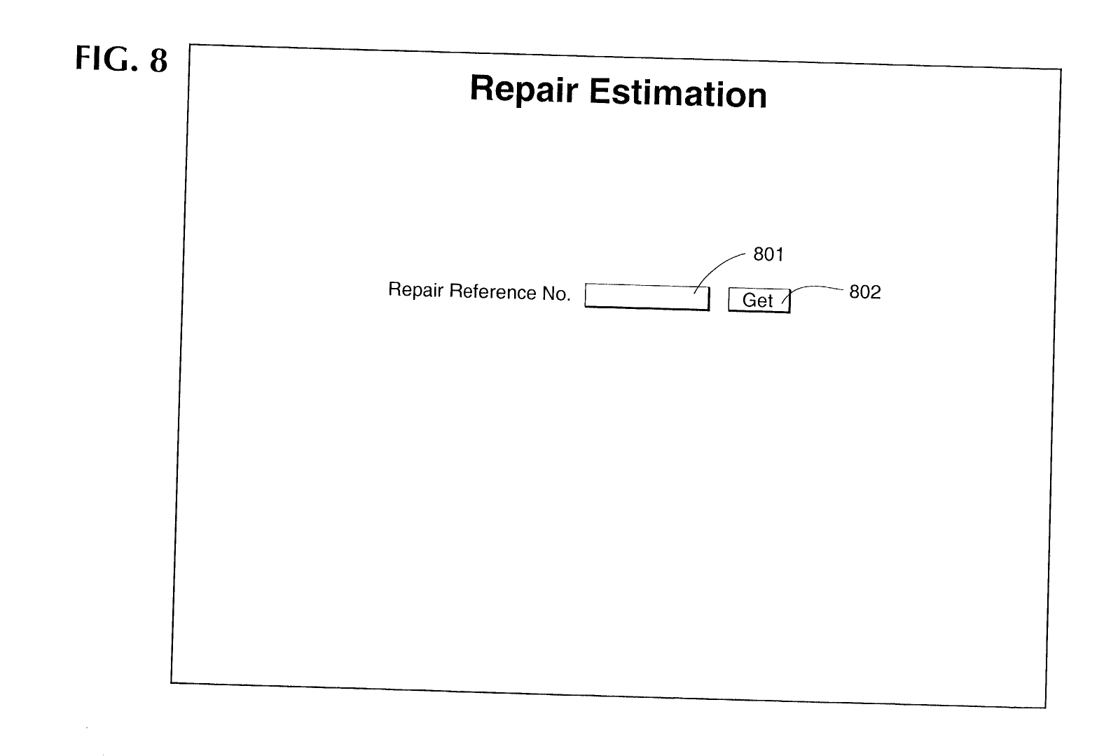

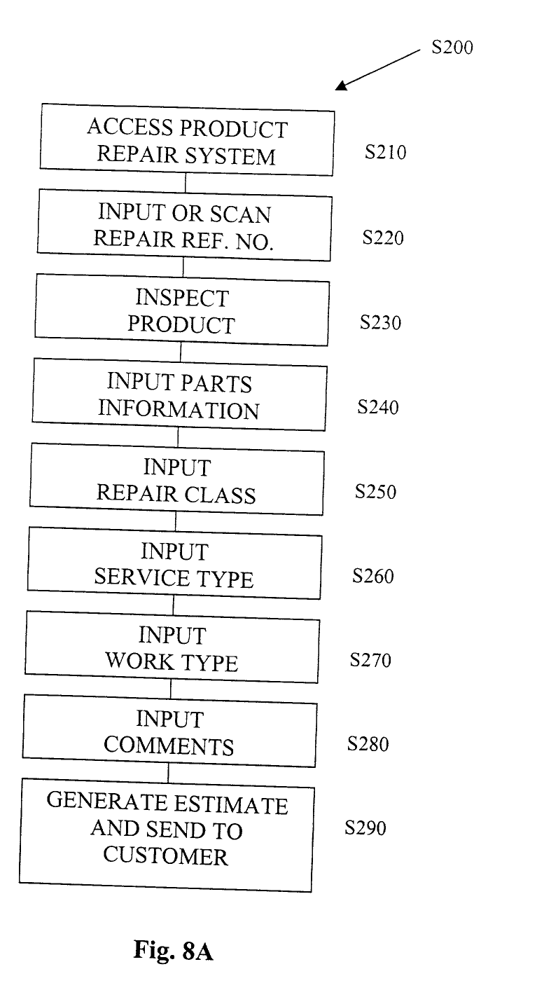

An estimating operator begins by obtaining on a client computer the Web page of FIG. 3, logging into the system with his user name and password to obtain the Web page of FIG. 4 and clicking on the estimation hyperlink 302 to obtain the Web page illustrated in FIG. 8. The steps of the estimating phase (S200) are shown in the flowchart of FIG. 8A, including the step of accessing the repair system (S210), as described above. Like the receiving phase, the estimating phase is typically conducted at FSRC and IASF facilities, but not at SUBC facilities.

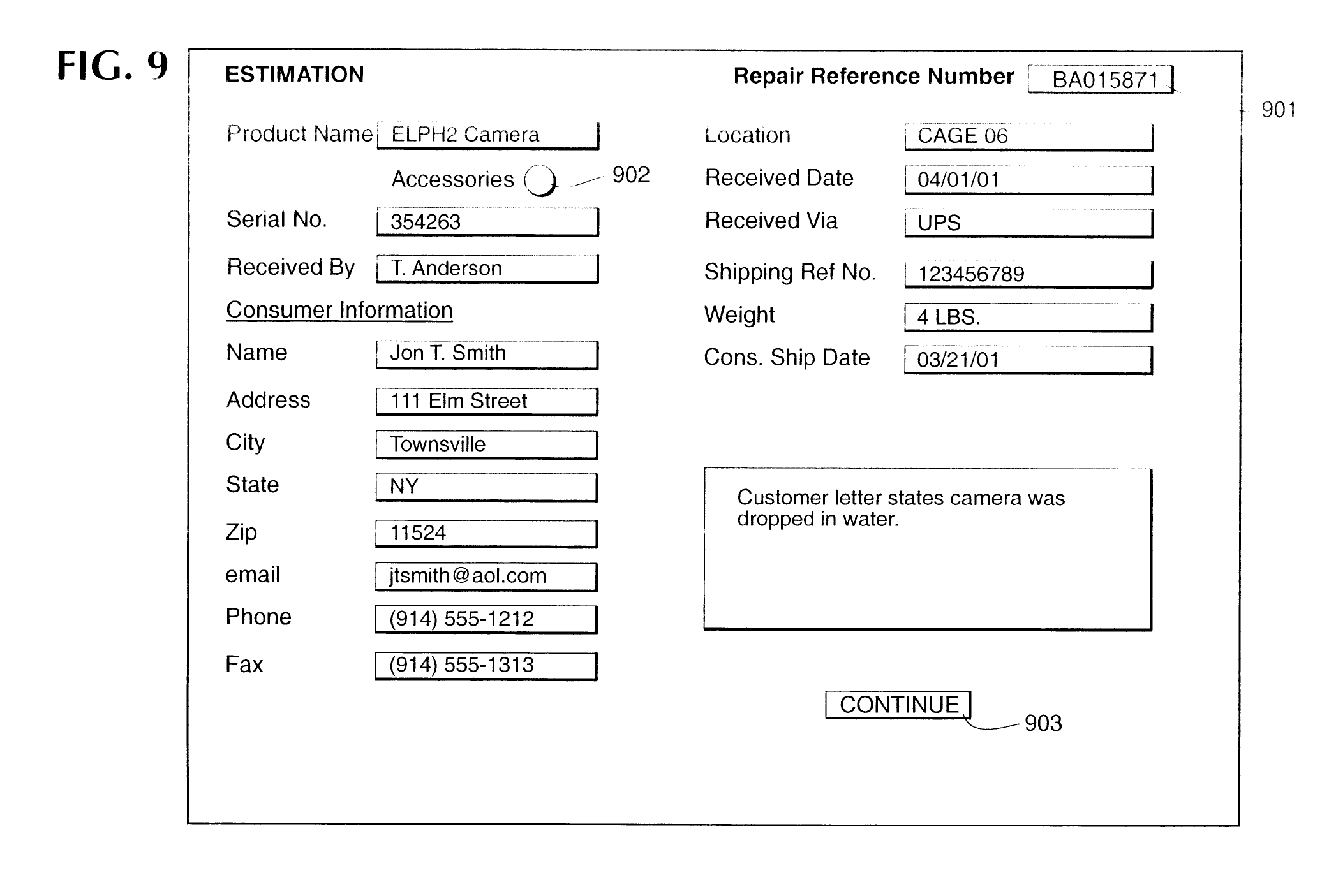

The Web page of FIG. 8 prompts the operator to enter the Repair Reference Number (S220) in field 801. This entry may be accomplished by reading the number off of the tag 707 and manually typing it in, or alternatively and preferably by scanning the bar code 701. In either case, once the reference number is input, the operator clicks the get button 802, to provide that information to the server 104; which server in turn retrieves from database 105 the data associated with that reference number (and hence the product at hand). The product intake data is provided to the operator by serving a Web page along the lines of FIG. 9, which Web page is similar to the Web page of FIG. 5, with all of the fields appropriately filled in. The Web page of FIG. 9 additionally displays in field 901 the assigned repair reference number. To view a listing of accessories that were received, the operator simply clicks button 902, and is presented with a Web page similar to the page of FIG. 5A, with the appropriate boxes checked, and additional accessories listed in the “other accessories” free-text field, if appropriate.

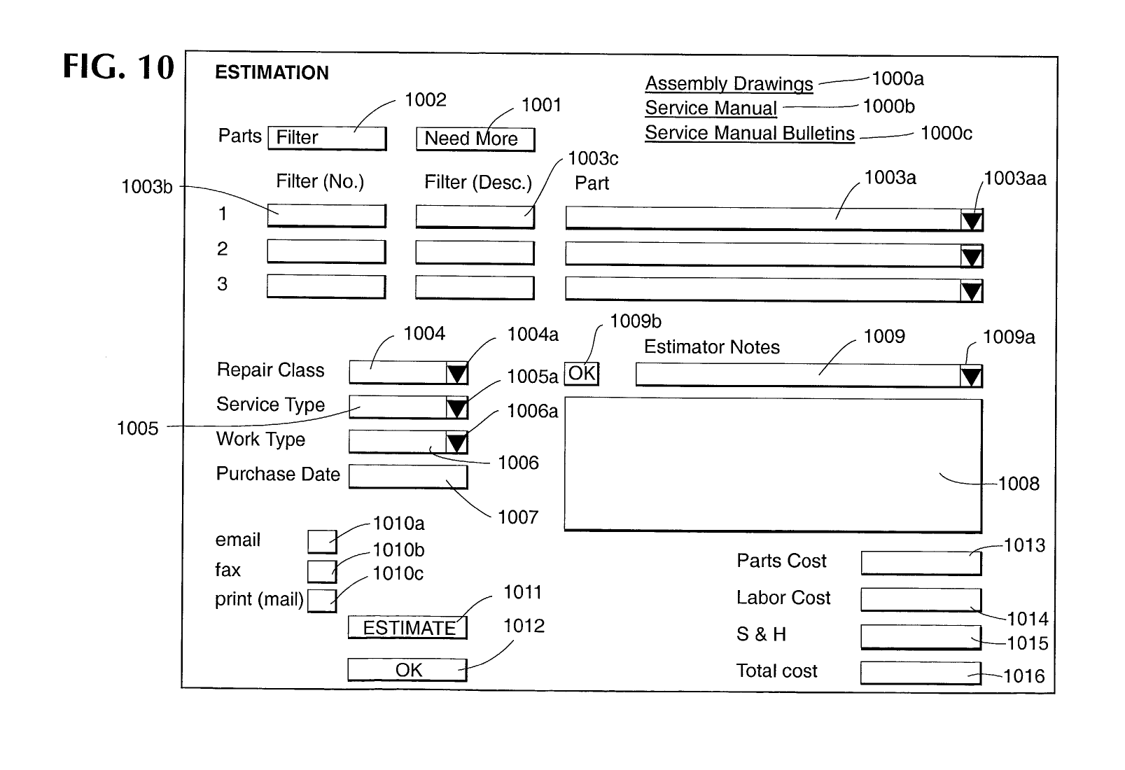

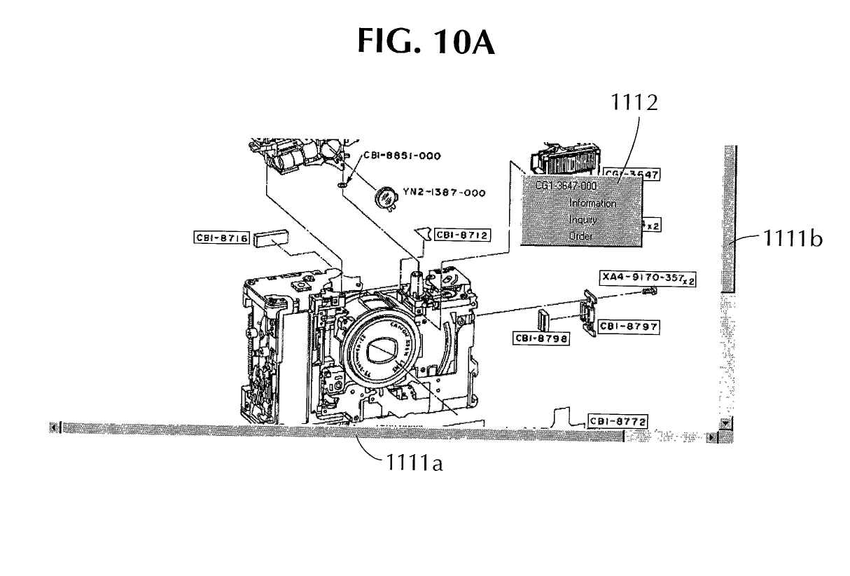

Once the operator has reviewed the core information, he clicks the continue button 903, to obtain the Web page illustrated in FIG. 10, through which he may enter cost estimation data, and be automatically provided with a cost estimation. Speaking generally, the total cost of repairs is the sum of the cost of the parts that must be replaced (parts cost); the cost of the labor for servicing the product (labor cost); and the cost of shipping the product back to the consumer (S&H). In accordance with the present invention, the operator enters certain information in the fields of the Web page of FIG. 10, which information is provided to the server 104. The server 104 processes that information in accordance with certain algorithms and in conjunction with certain data retrieved from database 105, to generate a cost estimation amount, which represents the amount to be charged to the consumer for the repairs.

The fields in the top portion of the Web page are for entering the parts that need to be replaced (S240). This entry is performed after the operator physically inspects the product (S230). The operator, of course, must be sufficiently trained so as to be capable of assessing which parts need to be replaced (as well as to be capable of assessing the extensiveness of the servicing required, as will be explained in greater detail below). The Web page is provided with fields sufficient to enter three separate parts; if more are needed, the operator simply clicks the “need more” button 1001, and is provided with a Web page having fields for entering additional parts.

The parts may be entered in a variety of ways (S240). One way is to initially click on the down arrow in the appropriate line (such as, for example, arrow 1003aa of line 1), to obtain a pull-down menu of all parts contained in the product. Selecting any part on the pull-down menu causes that part to appear in the corresponding field of the appropriate line, such as in this working example field 1003a of line 1. The pull-down menu itself is prepared by the server 104, based upon data retrieved from database 105, which stores parts data regarding each and every part in each and every product that is supported by the system.

In many cases, the complete listing of parts that comprise a product is exceeding long, such that reviewing a pull-down menu of all such parts is an onerous and time-consuming task. In these cases, the operator may use one of the filter fields (such as for example, filter field 1003b or 1003c of line 1) to obtain a truncated pull-down menu. For example, the operator may enter a few characters of a part number, e.g. “CG1-6846,” into field 10036; or a brief description of a part, e.g. “COVER”, into field 1003c. Upon clicking the “filter” button 1002, the operator would be presented with a menu of a shortened parts list, containing only those parts in the product that contain the characters entered in the filter field. This list would include the complete entry for the part which the operator seeks, e.g. “CG1-6846-000-COVER ASSEMBLY, FRONT (E),” which would appear in field 1003a when the operator selects it.

Once all the needed parts have been entered, the operator turns to the repair class field 1004, in which he enters information describing the extensiveness of the repairs that must be accomplished (S250), which information the server 104 uses to estimate the labor charges. In a preferred embodiment of the present invention, the operator inputs this information by selecting a repair class from among a pre-determined list of repair classes, each of which represents a different level of required servicing.

For example, an appropriate list of repair classes might be:

MINOR

STANDARD

MAJOR

EXTENSIVE

each of which describes a level of servicing more extensive than its predecessor. That is to say, the MINOR class is for very easy repairs; the STANDARD class is for more difficult repairs; the MAJOR class is for still more difficult repairs; and the EXTENSIVE class is for the most difficult repairs.

The estimating operator begins by assessing the level of required service, and characterizing it in terms of one of the available repair classes. The operator then clicks on the down arrow 1004a, to obtain a pull-down menu of the repair classes, and selects the appropriate one to enter it into the repair class field 1004.

The service type field 1005 is for inputting the service type for the product at issue (S260). The service type is preferably selected by the operator from among a pull-down menu containing a predetermined list of service types, the pull-down menu being accessible by clicking the down arrow 1005a. An exemplary pull-down menu might include the following options:

CHARGE

NO CHARGE

WARRANTY

OUT OF SERVICE TERM

BEYOND ECONOMICAL

In this example, CHARGE indicates that the consumer will be charged for the repairs; NO CHARGE that the repairs will be done and the consumer will not be charged out of courtesy or for some other non-warranty reason; and WARRANTY that the repairs will be done and the consumer will not be charged because the product is covered by an in-force warranty. The remaining two options indicate that the product will not be repaired and will be returned to the consumer as is, OUT OF SERVICE TERM because the product is so old that it is no longer supported by the system; and BEYOND ECONOMICAL because the damages are so extensive that the costs of repairs would exceed the products replacement value. The estimating operator, of course, must be sufficiently trained so as to be capable of inspecting the product and the associated materials (such as the letter from the consumer, the product's paperwork, etc.), and make a determination as to what the appropriate service type should be.

The work type field 1006 is for inputting the type of work to be performed (S270). This information is also preferably input with the aid of a pull-down menu (accessible by clicking the down arrow 1006a), an appropriate example of which might be:

REPAIR

CLEAN/CHECK

REPLACE

RETURN

with REPAIR indicating that the product is to be repaired by the servicing operator in the next phase; CLEAN/CHECK indicating that the product is to be cleaned and checked by the servicing operator; REPLACE, that a brand new product is to be shipped to the consumer; and RETURN that the product is to be returned to the consumer in its current condition.

The purchase date field 1007 is for inputting the purchase date of the product. This information is required if the service type is WARRANTY, so that the server 104 can verify that the product warranty is still in force.

A text field 1008 is provided for inputting any notes or comments that the estimating operator may have (S280). In a preferred embodiment of the present invention, the clicking of arrow 1009a provides a pull-down menu of commonly desired notes, such as for example, “Equipment damaged by liquid substance,” “Required repairs not covered by warranty,” “Cost of repair would exceed replacement value,” etc. The operator may select a comment from the menu, and click OK button 1009b to cause that comment to be entered into the text field 1008. Alternatively, or additionally, the operator may input manually a comment not offered on the pull-down menu. Multiple comments, either from the pull-down menu or manually input, may be entered into the text field 1008.

To aid the estimating operator in inspecting the products and assessing the parts which need to be replaced and the extensiveness of the damages, the Web page of FIG. 10 is provided with hyperlinks 1000a-1000c, which may be clicked to obtain electronic versions of technical information, including for example assembly drawings (1000a), a service manual (1000b) and service manual bulletins (1000c) for the product at issue. An example of an electronic assembly drawing obtained by clicking hyperlink 1000a is depicted in FIG. 10A. The figure shows a portion of an assembly drawing for a camera. The Web page is provided with a right-left scroll bar 1111a and an up-down scroll bar 1111b, each of which may be utilized to view the unshown portions of the drawing. The drawing depicts an exploded view of the camera, and shows the individual parts of the device, as well as how those parts fit together. All parts are labeled with their part number.

In a particularly preferred embodiment of the present invention, the clicking on an individual part or its part number causes a menu box to open through which additional information about that part may be obtained, or additional activities with respect to that part may be taken. Such a menu box 1112, for part number CG1-3647-000, is depicted in FIG. 10A, and includes menu items “Information,” “Inquiry” and “Order.” Clicking the “Information” item provides a Web page or pop-up box having information on pricing and availability of the part, and a list of all other products which use it. Clicking the “Inquiry” item provides a Web page or pop-up box having information as to whether the operator has already placed prior orders for that part, and the quantities involved. Clicking the “Order” item provides a mechanism (such as for example a Web page or a pop-up box) that enables the operator to submit an electronic order for the part. These menu items, of course, are exemplary only, and alternatives are plainly possible.

Returning to FIG. 10, boxes 1010a-1010c are provided for the operator to indicate the manner in which the consumer is to be notified. One, two or all of the boxes may be clicked, to cause the system to generate a message to the consumer in the indicated fashion (1010a for e-mail; 1010b for facsimile; 1010c for a hard copy letter, delivered via U.S. Mail or by some other carrier). Typically, an “x” appears in a box that has been clicked. In the case when the repairs are charge repairs, the consumer would be provided with the cost estimate, and the actual repairs would not occur until approval is obtained.

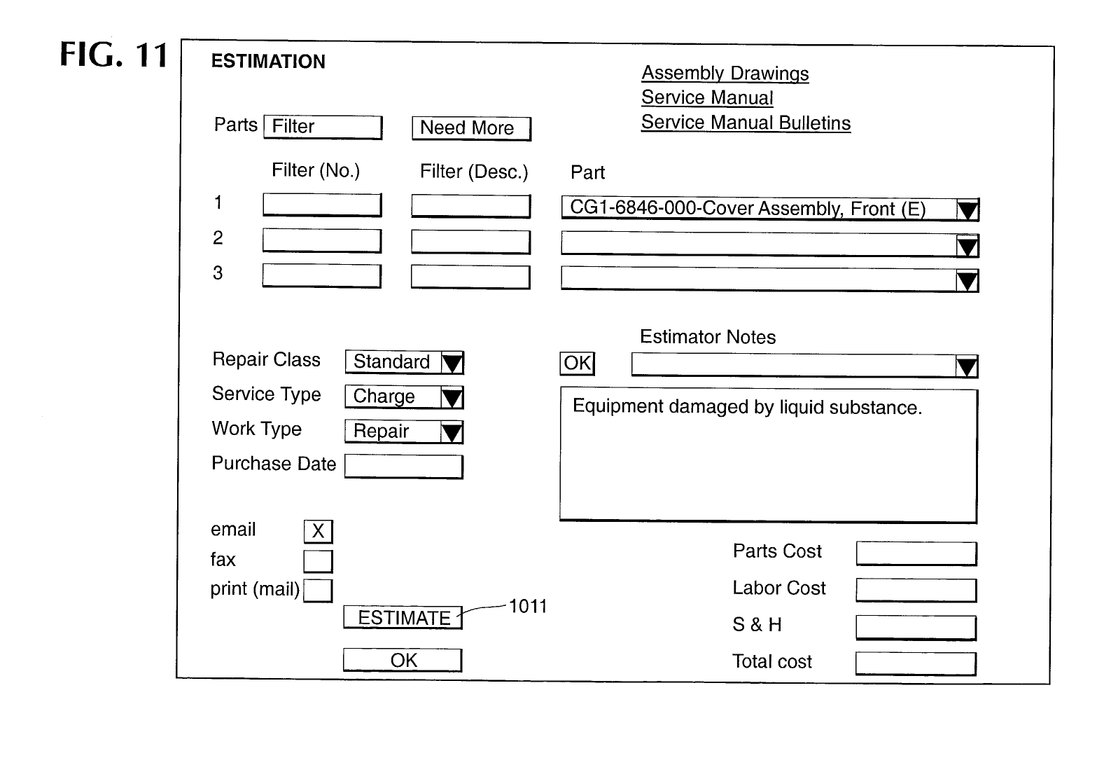

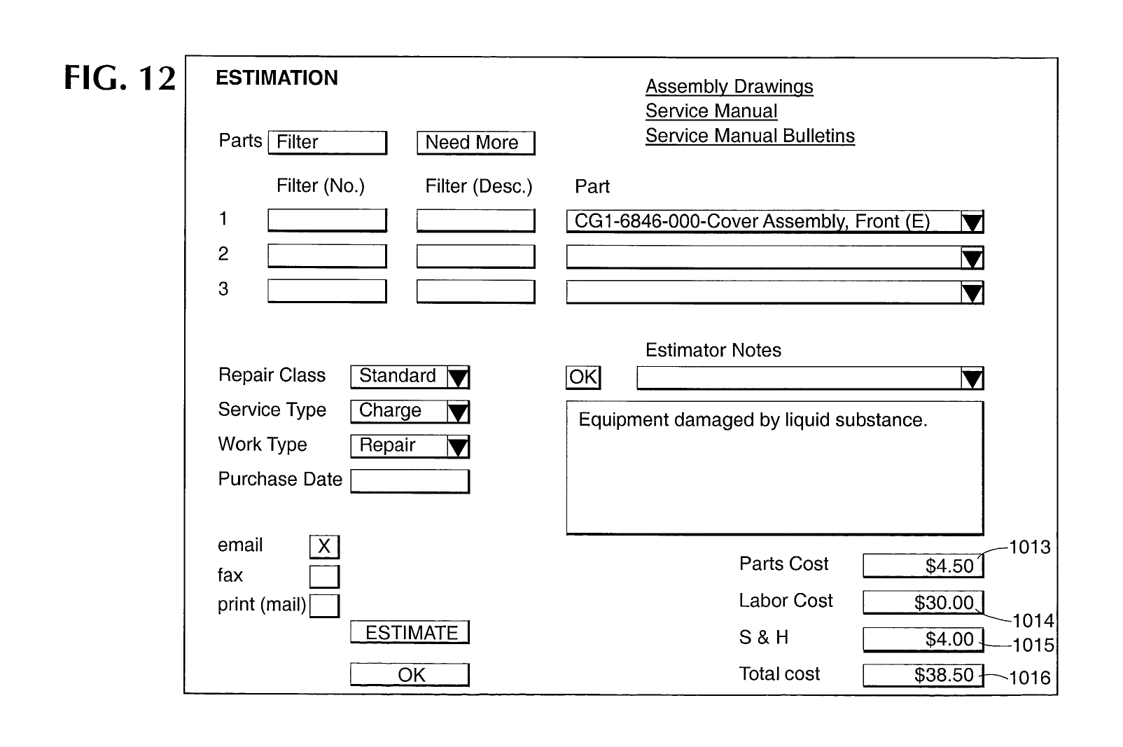

Once all required information is input (see FIG. 11), the operator clicks the ESTIMATE button 1011, to transmit the input information to the server 104 (S290). The server 104 then processes that information to determine cost estimates for parts, labor and shipping and handling, and a total cost estimate. The server 104 then serves the client a Web page like that of FIG. 11, but with the cost estimate information filled-in the appropriate fields 1013-1016 (see FIG. 12).

The server determines the parts cost by retrieving from the database 105 the costs of all parts entered by the estimating operator, and summing them. In some embodiments of the present invention, the parts cost may be adjusted in accordance with certain formulas. For example, if the client computer is an IASF, the parts cost may be adjusted upward by a certain factor. This causes the IASF to charge more for the part to the consumer than it will itself be charged by the manufacturer (or other supplier of the part), allowing the IASF to realize a profit on its supply of the new part to the consumer.

The shipping cost is determined by retrieving from the database 105 the cost of shipping the product at issue, using a rate table of the current carrier of choice. The rates in the rate table may be accessed by the weight of the product to be shipped, which weight was input during the receiving phase. Alternatively, the server 104 could communicate with servers of several different carriers using established protocols, such as electronic data interchange (EDI) protocols, transmitting to the carrier servers the weight, starting location and destination of the product, and receiving a price quote for shipping, to obtain the most competitive rate.

The manner in which, speaking generally, the metric for determining the labor cost estimate determined in accordance with the present invention uses the assigned repair class, a price table which cross-references price classes and repair classes. In the system of the present invention, each and every product that is supported is assigned to a price class, based upon the size of the product, the complexity of the product, the difficulty of servicing the product, etc. Supported products are assigned price classes when the system is designed. For example, in a system that supports 1700 products, each product might be assigned to one of 100 price classes. A table is generated and stored in database 105, which table cross-references price classes and repair classes, and includes for each price class-repair class intersection the labor cost to be charged for effecting the repairs. These values are also assigned when the system is designed.

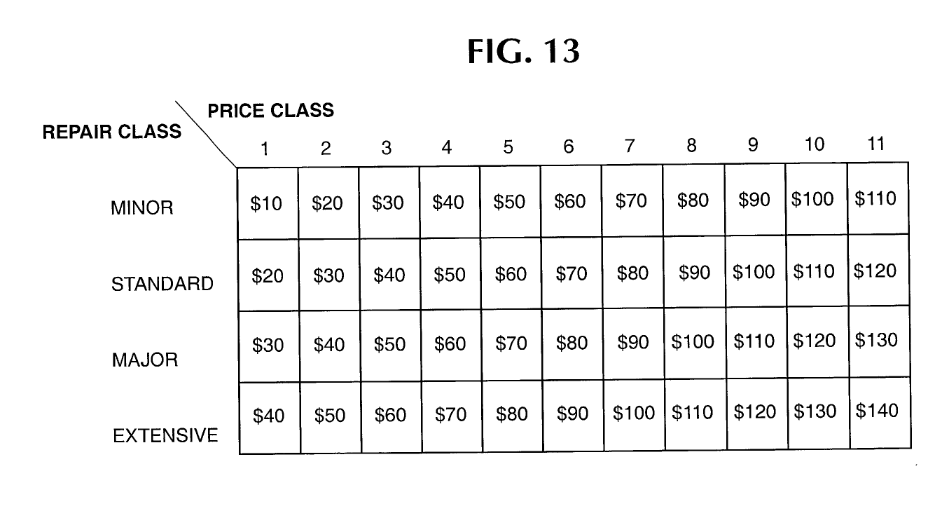

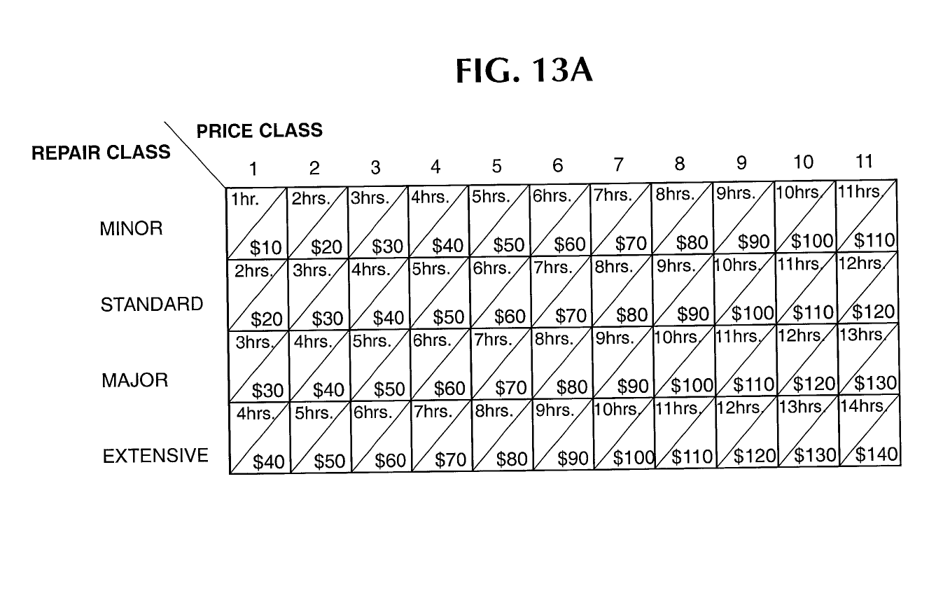

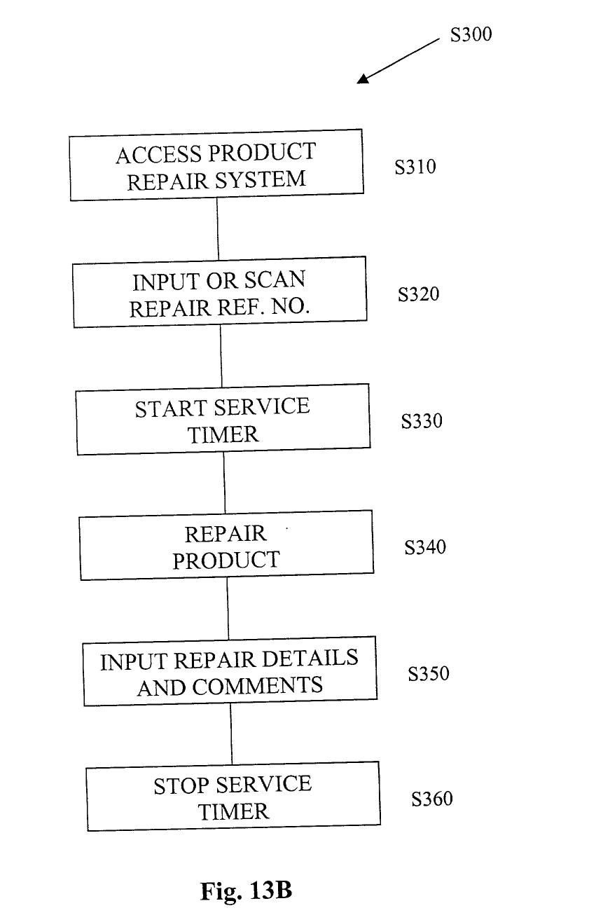

An example of such a table is illustrated in FIG. 13. In this example, there are 11 price classes 1-11 and four repair classes MINOR, STANDARD, MAJOR and EXTENSIVE. Speaking generally, price class 1 is for those supported products that are easiest to repair and price class 11 is for those supported products that are most difficult to repair. Each intersection includes the amount to be charged to the consumer for effecting the relevant level of repairs (MINOR, STANDARD, MAJOR, EXTENSIVE) on that class of product (1-11). The charges given in FIG. 13 are of course for illustrative purposes only, and may or may not bear any relation to actual hours and charges, either in absolute or relative terms.

In order to determine the amount to be charged to a consumer for conducting the repairs, the server 104 queries the table by providing to the database 105 the price class of the product at issue, and the repair class that the estimating operator has assigned. The database 105 then returns to the server the dollar amount to be charged, which the server in turn provides to the client computer, such as, for example, by providing the amount in field 1013. For example, if the product were in price class 2 and the repair class designated were in STANDARD, the amount retrieved from the table of FIG. 13 and returned to the server 104 would be $30. It should be noted that the price class of the product need not be display to the estimating operator, or to any operator of the system.

In an alternative embodiment of the present invention, the entries in the table include not only the amount to be charged to the consumer for the repairs, but also the estimated amount of time (such as, for example, in numbers of hours) it should take a service technician to perform the relevant level of repairs on a product of the relevant price class. An example of such a table is illustrated in FIG. 13A. Once again, the numbers of hours and charges given in FIG. 13A are for illustrative purposes only, and may or may not bear any relation to actual hours and charges, either in absolute or relative terms.

In a preferred embodiment of the present invention, products are assigned initial price classes, and initial dollar amounts (and hour amounts, if relevant) are entered into the table when the system is first designed. The price class assignments and dollar (and hour) amounts may be later changed, however, either manually by an authorized operator, and/or automatically by the system as it tracks the actual amount of time that the various types of repairs (e.g. MINOR, STANDARD, MAJOR and EXTENSIVE) take to completed on particular products. This latter automatic technique will be discussed in greater detail below.

At any rate, once the estimating operator is provided with the Web page of FIG. 12, he reviews it; and if he is satisfied with all of the information contained thereon, clicks the OK button 1012 to approve it. This approval causes the server to automatically generate a message to the consumer, with the specifics dependent upon the data input and generated during the estimation phase. For example, if the service type is CHARGE, the message will communicate to the consumer the amount that he will be charged for the repairs (with a break-down in terms of parts, labor and shipping), and will solicit the consumer's approval to perform the repairs. The message may alternatively explain that the repairs will be performed for free, either out of courtesy (NO CHARGE service type) or because the product is under warranty (WARRANTY service type). Or, the message may indicate that the product will not be serviced, either because its service term has expired (OUT OF SERVICE TERM service type) or because the damages are too extensive (BEYOND ECONOMICAL service type), and will be shipped back to the consumer. In any of the cases, other information that may be gleaned from the data input by the estimating operator or generated by the server 104 may be provided in the message as well.

The message may be automatically transmitted to the consumer via e-mail if box 1010a was checked; automatically transmitted to the consumer via facsimile if box 1010b was checked; and printed out in letter form, along with a mailing envelope, if box 1010c was checked. Alternatively, the e-mail and facsimile may be automatically generated, but not actually transmitted until they are approved by the estimating operator. It will be readily apparent to those skilled in the art that the contact information for the consumer (whether e-mail address, facsimile number or street address) is already part of the data record for the product, that was created when the product was received during the receiving phase.

Once the communication is transmitted to the consumer, the estimating phase is completed, what happens next to the product is dependent on the service type designated by the estimating operator. If the designated service type is NO CHARGE or WARRANTY, no consumer approval is required for the repairs to be performed, and the product is accordingly routed (with its bar code tag) to a service area, where it is held until it is taken by a service operator and entered into the service phase. If the service type is CHARGE, on the other hand, then repairs may not be performed until consumer approval is obtained. Accordingly, the product is in that case routed to a holding area, where it is held until such approval is received. Once approval is received, it is routed to the service area to await service, as described above. Finally, if the service type is OUT OF SERVICE TERM or BEYOND ECONOMICAL, then the product is routed to a shipping area, to await entry into the shipping phase, for shipment back to the consumer.

As discussed above, the receiving phase and estimating phase typically takes place at an FSRC facility or a IASF facility, but not a SUBC facility. In some cases, however, especially in those cases in which receiving and estimating occurred at an FSRC, the product is routed for actual service to a SUBC. The SUBC in that case takes the product, repairs it and routes it back to the FSRC for shipping (or may alternatively ship it directly to the consumer). Typically, the FSRC will itself bill the consumer, and will in turn pay the SUBC for the work that it performed. The present invention advantageously supports this relationship, in that it allows the SUBC, by scanning the bar code on the tag attached to the product that it was provided, to retrieve all information associated with the product, and to conduct the product through the service phase.

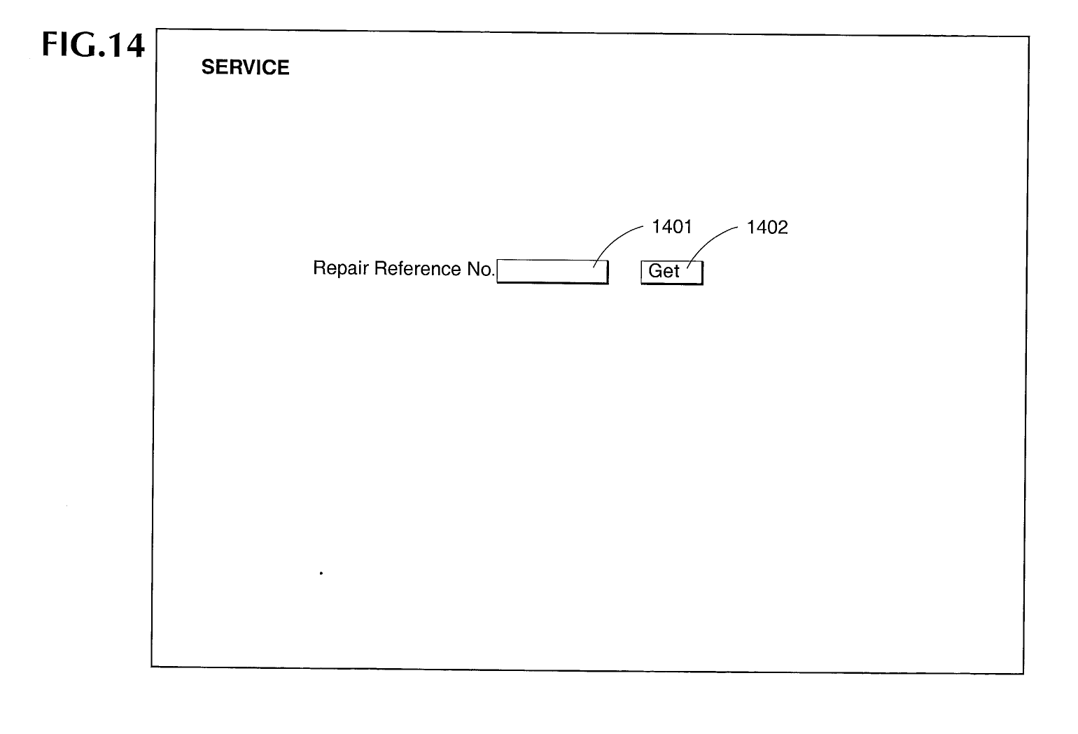

The service phase, therefore, may be initiated by an servicing operator at either an FSRC, a SUBC or an IASF. In either case, as shown in the flowchart of FIG. 13B, the servicing operator logs on to the system (see FIG. 3) and clicks the service hyperlink 303 (see FIG. 4), upon which his client computer is served the Web page shown in FIG. 14 (S310). This page prompts the operator to enter the repair reference number (either by typing or, preferably, by scanning the bar code), and submit it to the server 104 by clicking the get button 1402 (S320).

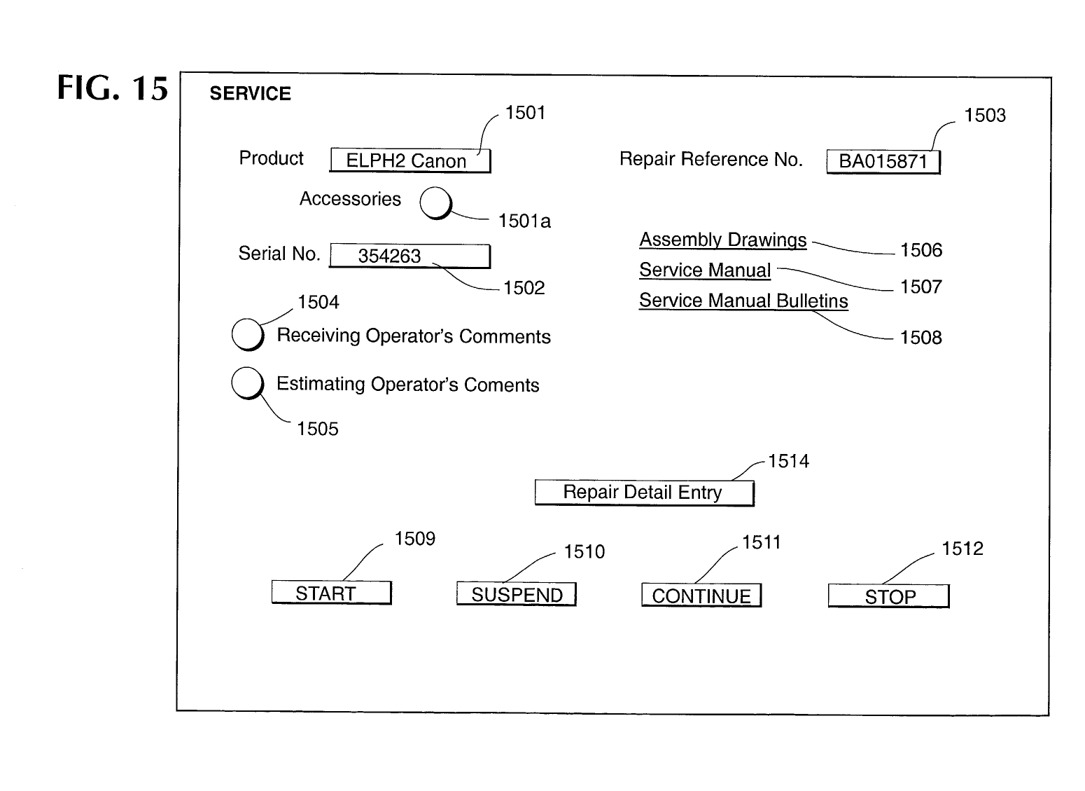

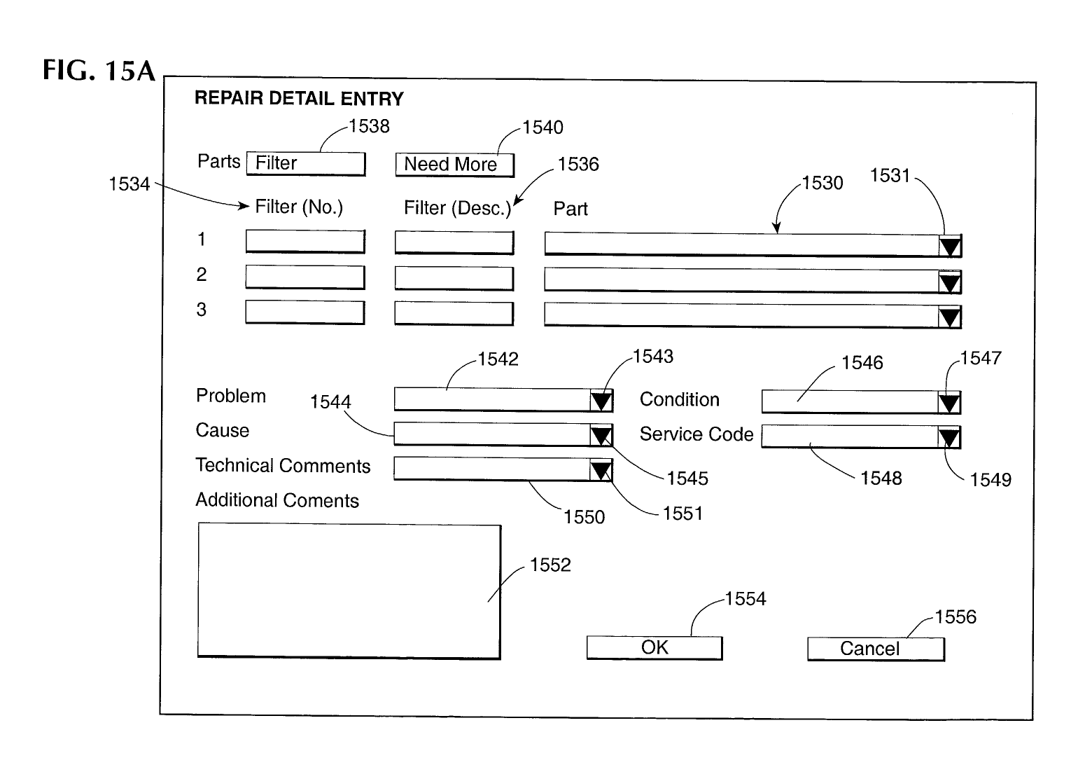

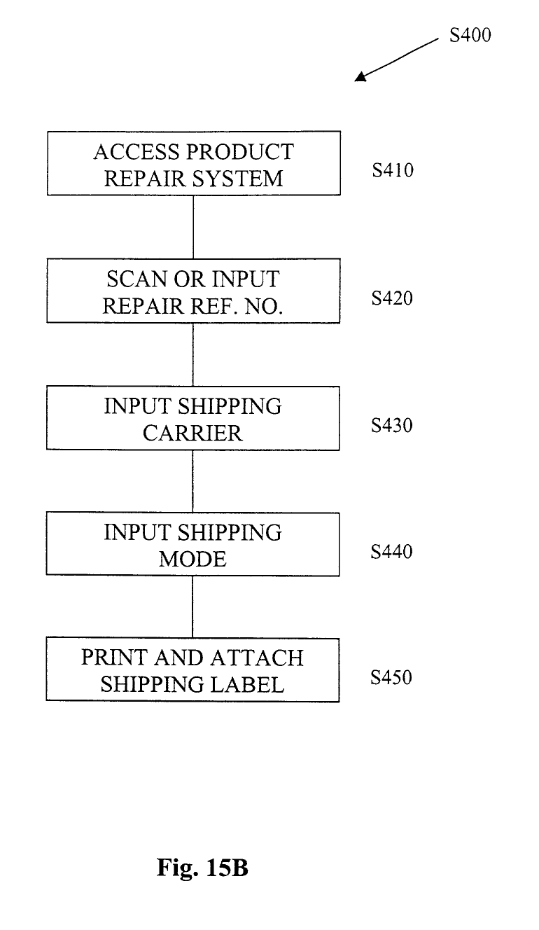

FIG. 15 depicts an example of a Web page which could be served to a client computer upon clicking the get button 1402. The information contained thereon is retrieved by the server 104 from the database 105, using the Repair Reference Number input by the operator. The actual types of information displayed on the Web page of FIG. 15 is, of course, explanatory only; any other information that was captured or generated in the earlier phases could be displayed as well.

In a particularly advantageous embodiment of the present invention, the amount of time that a servicing operator takes to a repair a product is measured by the system. When a servicing operator begins to repair a product, he clicks the start button 1509 (S330). This action causes the server 104 to start a timer, in a manner that is well known in the art. If during the course of repair the operator must cease his work on the product (such as, for example, to take a lunch break), he simply clicks on the suspend button 1510. The single action of clicking of the suspend button 1510 might cause the server 104 to suspend the timer.

Alternatively, the clicking of the suspend button 1510 might cause a menu box to appear, prompting the operator to select a description from among several options that describe reasons why work on the product has ceased. One example of a suitable menu for such a box is as follows:

OUT OF WORK BENCH

WAITING FOR PARTS

WAITING FOR MORE INFORMATION FROM CUSTOMER

LONG TIME TEST OR ADJUSTMENT

WAITING FOR TECHNICAL INFORMATION

WORK BREAK

In the case where this menu box technique is used, the selection of the menu item by the operator causes the server 104 to suspend the timer. The server stores the reason for the suspension in the database 105 as part of the data record of the product.

When the operator resumes work on the product, he clicks the continue button 1511, causing the server 104 to start the timer again. When the operator has completed the repairs (S340) to the product, he clicks the stop button 1512, causing the server 104 to stop the timing and to store the total repair time in the database 105 as part of the data record of the product (S360).

The capturing of the actual repair time makes the system of the present invention more dynamic and adaptable, in that the captured time data may be used to adjust the initial price class assignment of the product to allow more accurate estimation of repair time. A convenient and preferred way to do this is to keep track of the actual repair times for a product in a given repair class for a certain number of repairs. These actual repair times are averaged and compared to the estimated labor hours stored in the price class-repair class table, e.g., the table shown in FIG. 13A, for the assigned price class and selected repair class.

If the average actual repair time is larger or smaller than the estimated labor hours retrieved from the table by some predetermined threshold, then the product may be assigned to a new price class that is higher or lower, as appropriate. This adjustment may be by whatever number of price classes is necessary to match the average actual repair time with the estimated labor hours stored in the table. Alternatively, the adjustment may be by only one price class in the first instance, followed by additional adjustments if the average actual repair time for the next predetermined number of repairs deviates sufficiently (i.e., by a predetermined threshold) from the estimated labor hours for the new price class.

For this technique to be effective, of course, the number of repairs that contribute to each average should be large enough such that a statistically significant sample of actual repair times is captured. Such a number might be, for example, 10, 50 or 100, depending upon the in nature of the product being repaired.

To discuss the above aspect of the present invention in terms of a concrete example, suppose that the specific table of FIG. 13A is used. That table indicates that a repair in the STANDARD repair class of a product assigned to price class 2 has an estimated repair time of 3 hours, an that the customer should accordingly to be charged $30 for the repairs. Assume that a certain product, such as the “ELPH2” camera, is initially assigned to price class 2. As various ELPH2 cameras are repaired using the system, the server 104 keeps a running average of the actual repair time expended by servicing operators. Once a predetermined statistically significant number of cameras have been repaired (such as, for example, 50 cameras), the server compares the average actual repair time to the 3 hour figure from the table. If, for example, the average actual repair time is 4.5 hours, the server reassigns the ELPH2 camera to next higher price class, i.e., price class 3, so that the table will provide a more accurate estimate of repair time for the ELPH2 camera.

In a preferred embodiment of the present invention, this feedback process occurs continuously and on a permanent basis, such that for each product, the price class assignment, in conjunction with the table, will yield a labor hour estimate that very closely approximates the actual repair time.

In addition to being used to adjust the price class assignments as described above, the measured repair time may also be used to increase or decrease the amount the consumer is charged for the repair, i.e., the consumer may be charged for the actual repair time rather than the estimate amount that he was given. This technique may prove to be impracticable, however, particularly with respect to an actual repair cost that is higher than the estimated cost, because only the estimated cost will have been approved by the consumer. Accordingly, the applicability of this latter technique will be limited to those instances in which the business realities allow it.

In addition to the start, suspend, continue and stop buttons 1509-1512, the Web page of FIG. 15 provides a button 1504 for obtaining a pop-up box containing the receiving operator's comments; and a button 1505 for obtaining a pop-up box containing the estimating operator's comments. Hyperlinks 1506-1508 are also provided, for obtaining the same online technical information available from the estimation Web page of FIG. 10.

As the servicing operator is repairing a product (S340), he may click on the “repair detail entry” button 1514 to access a repair detail entry screen (S350), an example of which is shown in FIG. 15A. The repair detail entry screen provides parts fields 1530 for entering the parts that are replaced during servicing. Initially, the parts fields 1530 may be filled with the parts entered during the estimation phase. The servicing operator may change, delete, or add additional parts, as necessary, to reflect the actual parts required to repair the product. Alternatively, the parts fields 1530 initially may be blank, and the servicing operator may enter all of the parts replaced during the repair.

The entry of the parts is accomplished in a manner similar to that described above with respect to the estimation process. The parts may be entered using pull-down menus 1531 or pull-down menus 1531 in conjunction with an applied filter. The filter is activated by making a partial entry in the “filter number” field 1534 or the “filter description” field 1536 and clicking on the “filter” button 1538. Additional parts fields may be accessed by clicking the “need more” button 1540.

The remainder of the repair detail entry screen allows the servicing operator to enter technical comments regarding the condition of the product and the type of repair performed. The “problem” field 1542 is for inputting the manner in which the product malfunction manifests itself. The problem may be entered using a pull-down menu 1543 presenting options such as, for example:

NO POWER

POOR DISPLAY

NOISY LOADING

WON'T LOAD

NO FLASH

The “cause” field 1544 is for inputting technical information regarding the cause of the problem, as determined by the servicing operator. The cause may be input using a pull-down menu 1545 presenting options such as, for example:

SAND

OLD WIRE

DEFECTIVE PART

MOISTURE

The “condition” field 1546 is for inputting, using a pull-down menu 1547, whether the problem is CONSTANT or INTERMITTENT. The “service code” field 1548 is for inputting, using a pull-down menu 1549, the action taken by the servicing operator, such as, for example:

REPLACE PART

MECHANICAL ADJUSTMENT

ELECTRICAL ADJUSTMENT

Additional actions taken by the servicing operator may be input using the “technical comments” field 1550. These actions may be input using a pull-down menu 1551 presenting option such as, for example:

RESET MICROPROCESSOR

ADJUST BATTERY CONTACTS

CLEAR FOREIGN SUBSTANCE

Additional technical comments also may be entered in a text field 1552 provided for that purpose.

Once the servicing operator has completed entering the repair detail information (S350), he may click on the OK button 1554 to save the information, or click on the cancel button 1556 to cancel any changes or additions to the technical comments. Either of these buttons returns the operator to the initial service screen (FIG. 15).

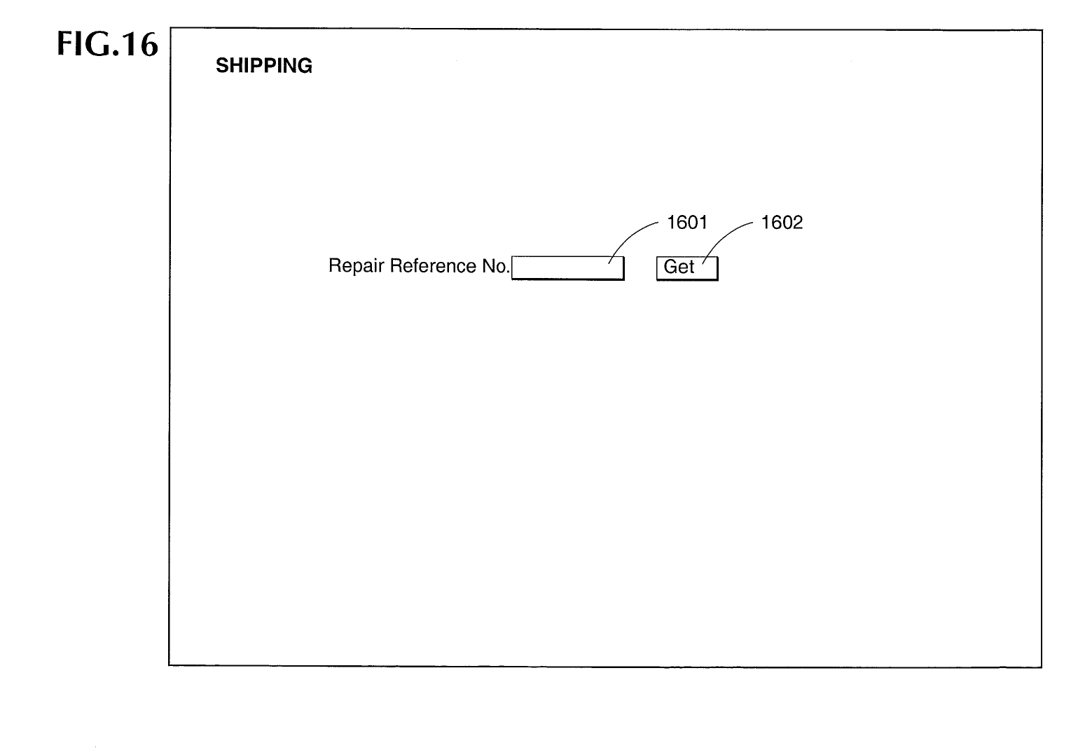

Following the service phase, the shipping phase may be initiated, either by the servicing operator at either an FSRC, a SUBC or an IASF, or by a dedicated shipping operator at any of those facilities. However, as discussed above, if the service is performed by a SUBC, the product may be sent to the FSRC for shipment to the consumer. In any event, as shown in the flowchart of FIG. 15B, to initiate the shipping phase, the operator logs on to the system (see FIG. 3) and clicks the shipping hyperlink 304 (see FIG. 4), upon which his client computer is served the Web page shown in FIG. 16 (S410). This page prompts the operator to enter the repair reference number (either by typing it in the box 1601 or, preferably, by scanning the bar code), and submit it to the server 104 by clicking the get button 1602 (S420).

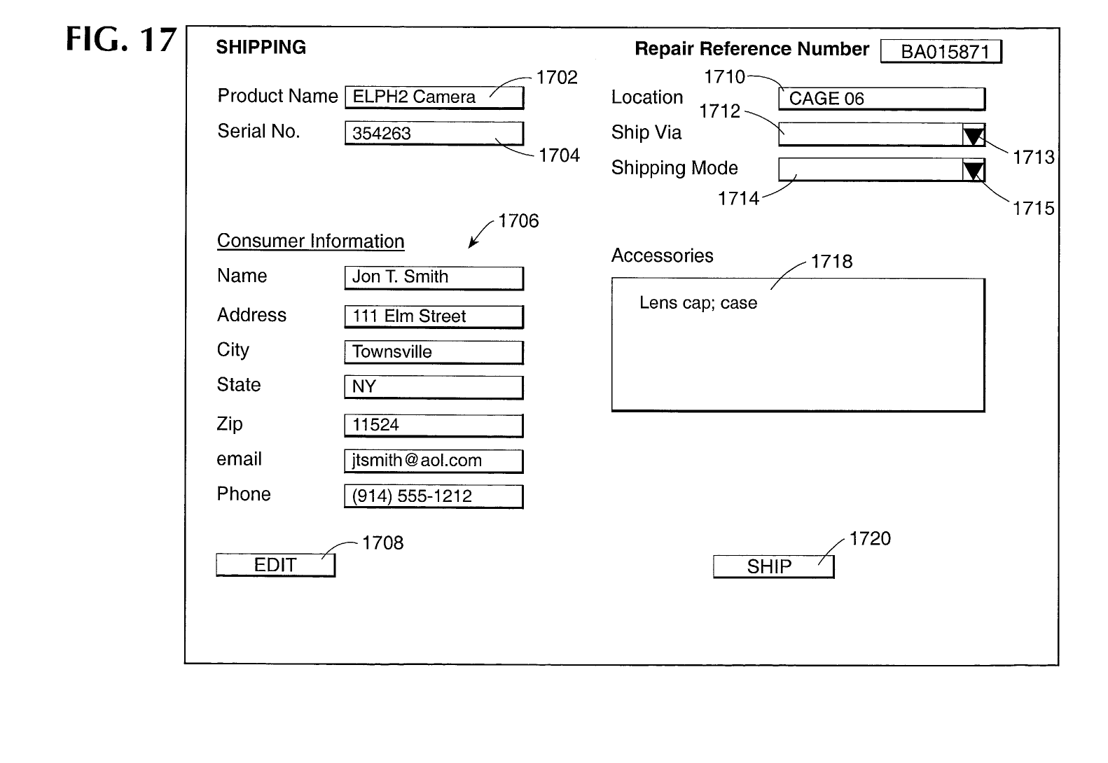

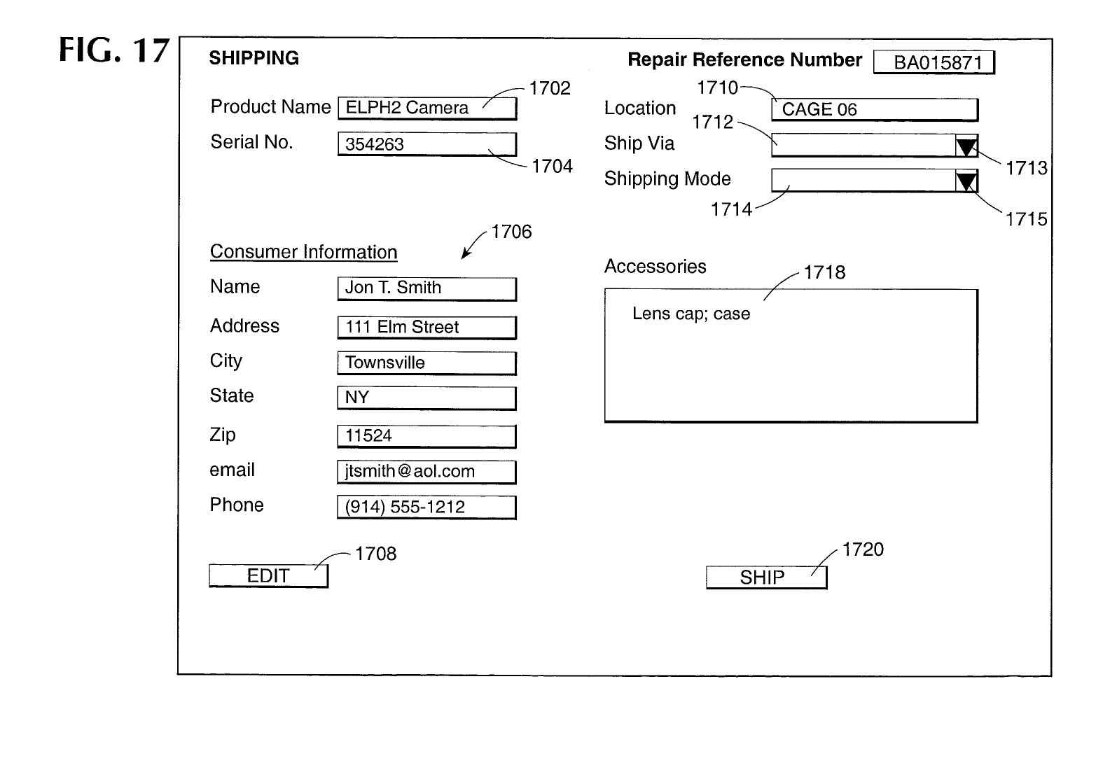

In one embodiment of the present invention, the operator is then served the shipping Web page illustrated in FIG. 17, which provides the product name 1702 and serial number 1704 and customer information 1706 as retrieved from the server. The operator may edit the customer address, if necessary, by clicking the edit button 1708. The Web page also provides the location 1710 of the product so that it may be retrieved, if necessary, from a storage facility for shipment.

The “accessories” field 1718 displays the accessories that were entered into the system upon receiving the product for repair. This allows the operator to ensure that all accessories sent with the product are returned to the consumer.

The shipping page also displays fields relating to the shipping carrier and mode of shipment. The “ship via” field 1712 allows the operator to select the shipping carrier (S430), e.g., UPS, Federal Express, etc. The “shipping mode” field 1714 allows the operator to select the particular mode of shipping depending upon the carrier (S440), e.g., ground, overnight air, second day air, etc.

Alternatively, the shipping carrier and shipping mode may be determined by the server. Maintained in the database 105 is a list of all shipping carriers, and their charges for specified transports. The server 104 accesses this information to determine which combination of shipping carrier and shipping mode is the most economical, given the nature of the product to be returned (such as its weight and dimensions) and the pick-up and delivery points. Preferably, the database 105 is updated periodically, to reflect changes in rates, newly negotiated contracts, etc. The shipping operator may be permitted to override these automatic selections.

Once the shipping carrier and shipping mode are selected, the Web server generates shipping label data (S450). The shipping label data include data sufficient for the client computer to direct a printer to print a shipping label that includes an identification of the destination and of the carrier service selected. The shipping label data also include data necessary to print an actualization code on the label, indicating that the shipping of the package on which the label is affixed has been pre-authorized and that the sender will pay the shipping costs. The shipping label data also preferably, includes data necessary to print the sender's address.

In practice, the carrier service typically contracts with the manufacturer to permit the transmission of the shipping label data, because it is the carrier service who will accept the authorization on the shipping label. Thus the carrier service itself is generally adapted to receive and transmit authorization information over a network.

The shipping label data is transmitted from the Web server 104 and received by the client computer with the client computer operably connected to a printer adapted to print shipping labels. The product to be shipped is placed into appropriate packaging by the shipping operator, and the printed label is affixed thereto (S450) for shipment to the customer.

Although illustrative embodiments have of the present invention have been described herein in connection with the accompanying drawings, it is to be understood that this invention is not limited to these embodiments and that various changes and modifications may be effected without departing from the spirit of the invention, as set forth in the following claims.

What is claimed is:

1. A network sever for facilitating the repair of a product, the server being adapted to:
receive information from the network identifying the product to be repaired;
receive information from the network identifying a repair class for the product, the repair class having been selected from among a predetermined set of repair classes and characterizing a level difficulty of repair for the product;
determine an estimated cost of repair for the product, based upon a metric that considers the repair class for the product;
track an actual amount of time required to repair the product; and
selectively modify the metric based upon the actual amount of time tracked.

2. A network server according to claim 1, wherein the metric considers the repair class for the product and a price class previously selected from a predetermined set of price classes and assigned to products of that type.

3. A network server according to claim 2, wherein the metric determines the estimated cost of repair for the product based upon a pre-configured table that cross-references repair classes and price classes and includes for each intersection of a repair class and a price class an estimated cost of repair.

4. A network server according to claim 4, wherein the metric is selectively modified by selectively reassigning a new price class to at least one type of product.

5. A network server according to claim 1, further adapted to provide technical information about the product useful in selecting an appropriate repair class for the product and effecting actual repairs.

6. A network server according to claim 5, wherein the technical information includes parts information for the product.

7. A system for facilitating the repair of a product, the system comprising:
means for receiving information identifying the product to be repaired;
means for receiving information identifying a repair class for the product, the repair class having been selected from among a predetermined set of repair classes and characterizing a level difficulty of repair for the product;
means for determining an estimated cost of repair for the product, based upon a metric that considers the repair class for the product;
means for tracking an actual amount of time required to repair the product; and
means for selectively modifying the metric based upon the actual amount of time tracked.

8. A system according to claim 7, wherein the metric considers the repair class for the product and a price class previously selected from set of predetermined price classes and assigned to products of that type.

9. A system according to claim 8, wherein the metric determines the estimated cost of repair for the product based upon a pre-configured table that cross-references repair classes and price classes and includes for each intersection of a repair class and a price class an estimated cost of repair.

10. A system according to claim 9, wherein the metric is selectively modified by selectively reassigning a new price class to at least one type of product.

11. A system according to claim 7, further comprising means for providing technical information about the product useful in selecting an appropriate repair class for the product and effecting actual repairs.

12. A system according to claim 11, wherein the technical information includes parts information for the product.

13. Computer code for facilitating the repair of a product, the system comprising:
code for receiving information identifying the product to be repaired;
code for receiving information identifying a repair class for the product, the repair class having been selected from among a predetermined set of repair classes and characterizing a level difficulty of repair for the product;
code for determining an estimated cost of repair for the product, based upon a metric that considers the repair class for the product;
code for tracking an actual amount of time required to repair the product; and
code for selectively modifying the metric based upon the actual amount of time tracked.

14. Computer code according to claim 13, wherein the metric considers the repair class for the product and a price class previously selected from set of predetermined price classes and assigned to products of that type.

15. Computer code according to claim 14, wherein the metric determines the estimated cost of repair for the product based upon a pre-configured table that cross-references repair classes and price classes and includes for each intersection of a repair class and a price class an estimated cost of repair.

16. Computer code according to claim 15, wherein the metric is selectively modified by selectively reassigning a new price class to at least one type of product.

17. Computer code according to claim 13, further comprising code for providing technical information about the product useful in selecting an appropriate repair class for the product and effecting actual repairs.

18. Computer code according to claim 17, wherein the technical information includes parts information for the product.

19. A method for facilitating the repair of a product that is received from a consumer, the product having been assigned a price class from among a predetermined set of price classes, the method comprising the steps of:
inputting product information and consumer information to a client computer;
transmitting the product information and consumer information to a network server;
inspecting the product to determine a difficulty of repairs;
characterizing the difficulty of repairs in terms of a repair class;
transmitting the repair class to the network server;
computing an estimated cost of repair for the product based upon the repair class for the product and the price class for the product; and
communicating the estimated cost of repair to the consumer.

20. A method according to claim 19, wherein the estimated cost of repair is computed based upon a pre-configured table that cross-references repair classes and price classes and includes for each intersection of a repair class and a price class an estimated cost of repair.

21. A method according to claim 20, wherein the estimated cost of repair is communicated to the consumer via electronic mail.

22. A method according to claim 20, wherein the estimated cost or repair is communicated to the consumer via facsimile.

23. A system for facilitating the repair of a product that is received from a consumer, the product having been assigned a price class from among a predetermined set of price classes, comprising:
a client computer that receives product information, consumer information and a repair class for the product, the repair class having been determined following a inspection of the product and characterizing the difficulties of repairs; and
a network server that:
receives the product information and the consumer information from the client computer,
computes an estimated cost of repair for the product based upon the repair class for the product and the price class for the product, and
communicates the estimated cost of repair to the consumer.

24. A system according to claim 23, wherein the server computes the estimated cost of repair for the product based upon a pre-configured table that cross-references repair classes and price classes and includes for each intersection of a repair class and a price class an estimated cost of repair.
